(19) United States
(12) Patent Application Publication
(10) Pub. No.: US 2026/0296031 A1
(43) Pub. Date: Oct. 1, 2026

(54) MAINTENANCE UNIT AND LIQUID EJECTION APPARATUS

(71) Applicant: SEIKO EPSON CORPORATION, TOKYO (JP)

(72) Inventors: Toshio KUMAGAI, SHIOJIRI-SHI (JP); Tomohiro NUMAJIRI, SHIOJIRI-SHI (JP); Shuzo MORITA, MATSUMOTO-SHI (JP)

(21) Appl. No.: 19/630,929

(22) Filed: Mar. 27, 2026

(30) Foreign Application Priority Data
Mar. 27, 2025 (JP) 2025-053361

(51) Int. Cl. B41J 2/165; B41J 2/17

(52) U.S. Cl. CPC B41J 2/16544; B41J 2/16511; B41J 2/16579; B41J 2/1707

(57) ABSTRACT

A maintenance unit includes a maintenance part configured to perform maintenance on a liquid ejection unit, a movement mechanism, and a positioning part. The movement mechanism moves the maintenance part in a first direction toward the liquid ejection unit. The maintenance part includes the engaging portion engageable with the positioning part. The movement mechanism includes a drive unit and a support configured to move in the first direction by power of the drive unit. The positioning part engages with the engaging portion that is moved in the first direction together with the support, and moves the engaging portion relative to the support in a direction parallel to the first direction, thereby positioning the maintenance part with respect to the liquid ejection unit.

The present application is based on, and claims priority from JP Application Serial Number 2025-053361, filed Mar. 27, 2025, the disclosure of which is hereby incorporated by reference herein in its entirety.

### BACKGROUND

### 1. Technical Field

The present disclosure relates to a liquid ejection apparatus and a maintenance unit that performs maintenance on a liquid ejection unit configured to eject a liquid.

### 2. Related Art

For example, JP-A-2020-40365 discloses a wiping device that is an example of a maintenance unit that performs maintenance on a liquid ejection unit. The wiping device includes a unit (an example of a maintenance part) including a maintenance member, and a lifting and lowering mechanism (an example of a movement mechanism) that lifts and lowers the unit. The lifting and lowering mechanism includes a moving member that supports the unit so as to be movable in lifting and lowering directions, a cam that comes into contact with a lower surface of the moving member, and a lifting and lowering motor that rotates the cam. When the moving member is lifted or lowered by the rotation of the cam based on the power of the lifting and lowering motor, the maintenance member advances or retracts with respect to a nozzle surface of the liquid ejection unit. The wiping device wipes the nozzle surface with the maintenance member by moving the unit including the maintenance member in a wiping direction with respect to the liquid ejection unit by the movement mechanism.

In addition, as maintenance of this type of liquid ejection unit, flushing (dummy ejection) in which a liquid not related to printing is ejected from a nozzle of the liquid ejection unit may be performed. By regularly or irregularly discharging a thickened liquid or the like in the nozzle by the flushing, the occurrence of an ejection failure of the liquid ejection unit is prevented. In this case, the maintenance unit that performs maintenance on the liquid ejection unit is a liquid receiving device that receives the liquid ejected from the liquid ejection unit by the flushing. The liquid receiving device includes, as the maintenance part, a liquid receiving portion that receives a liquid. The liquid receiving portion includes a liquid receiving member as the maintenance member. The liquid receiving member may be a liquid receiving container such as a cap or a flushing box, or may be cloth that can be unwound and wound up. When the liquid receiving member is cloth, the liquid receiving portion includes cloth, a delivery roller that delivers the cloth, and a winding roller that winds up the cloth. The liquid ejected from the liquid ejection unit by the flushing is received by a liquid receiving surface of the cloth facing the nozzle surface.

The maintenance unit such as the wiping device or the liquid receiving device performs appropriate maintenance by disposing the maintenance member, which faces the liquid ejection unit, in a posture parallel to the nozzle surface. Positions of the maintenance member and the liquid ejection unit in an advancing-retracting direction when the maintenance member is at a maintenance position are required to have a predetermined accuracy or higher.

JP-A-2020-40365 is an example of the related art.

However, in the maintenance unit disclosed in JP-A-2020-40365, the position when the maintenance part is lifted to the maintenance position is affected by dimensional variations of components of the lifting and lowering mechanism, assembly errors of the components, and the like. The positional accuracy of the maintenance position when the maintenance part moves toward the nozzle surface of the liquid ejection unit tends to decrease as a movement amount of the maintenance part increases. As described above, in the maintenance unit in the related art, it is difficult to secure both the movement amount and the positional accuracy of the maintenance part. Therefore, there is room for improvement in securing both the movement amount and the positional accuracy of the maintenance part. Although the movement direction of the maintenance part is determined according to the orientation of the liquid ejection unit, the same problem occurs in a maintenance unit in which the movement direction of the maintenance part is a direction intersecting a vertical direction at an acute angle, a horizontal direction, or the like.

### SUMMARY

A maintenance unit for solving the above problem is a maintenance unit to be used in a liquid ejection apparatus including a liquid ejection unit, the maintenance unit including: a maintenance part configured to perform maintenance on the liquid ejection unit; a movement mechanism configured to move the maintenance part in a first direction toward the liquid ejection unit; and a positioning part. The maintenance part includes an engaging portion engageable with the positioning part. The movement mechanism includes a drive unit and a support configured to move in the first direction by power of the drive unit and support the maintenance part. The positioning part engages with the engaging portion of the maintenance part that is moved in the first direction together with the support, and moves the maintenance part relative to the support in a direction parallel to the first direction to position the maintenance part with respect to the liquid ejection unit.

A liquid ejection apparatus for solving the above problem includes: the maintenance unit; and the liquid ejection unit.

### BRIEF DESCRIPTION OF THE DRAWINGS

FIG. 1 is a schematic front view of a liquid ejection apparatus according to an embodiment.

FIG. 2 is a partial front view of the liquid ejection apparatus.

FIG. 3 is a perspective view of a body frame and a maintenance unit.

FIG. 4 is a front view of the body frame and the maintenance unit.

FIG. 5 is a perspective view of the maintenance unit in a state where a maintenance part is pulled out to a work position.

FIG. 6 is a perspective view of the maintenance part.

FIG. 7 is a perspective view of a movement mechanism in a lowered state.

FIG. 8 is a perspective view of the movement mechanism in a lifted state.

FIG. 9 is a front view of an upper portion of the maintenance part.

FIG. 10 is a front view of an opening of the support and an engaging portion.

FIG. 11 is a perspective view of a positioning part.

FIG. 12 is a side view of the positioning part.

FIG. 13 is a side view of the maintenance part moving in a first direction and the positioning part.

FIG. 14 is a side view of the maintenance part positioned at a maintenance position by the positioning part.

FIG. 15 is a front view of a main part of the maintenance part positioned at the maintenance position and a liquid ejection unit.

FIG. 16 is a perspective view of a positioning part according to a modification.

FIG. 17 is a schematic diagram illustrating an operation of the positioning part according to the modification.

FIG. 18 is a schematic diagram illustrating a maintenance part and a liquid ejection unit according to a modification different from that in FIG. 17.

FIG. 19 is a schematic diagram illustrating a configuration and an operation of a positioning part according to a modification different from that in FIG. 18.

### DESCRIPTION OF EMBODIMENTS

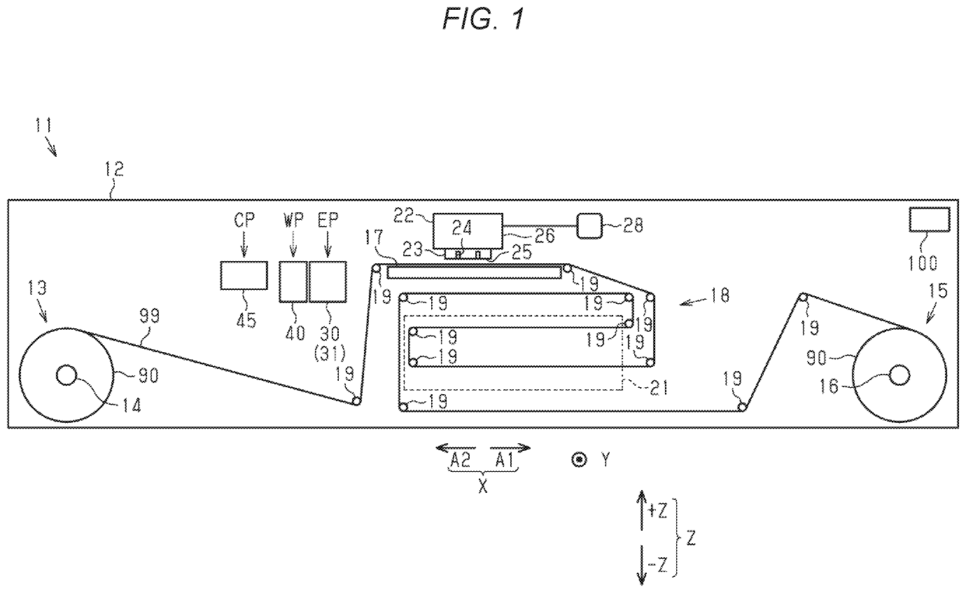

Hereinafter, an embodiment of a liquid ejection apparatus will be described with reference to the drawings. A liquid ejection apparatus 11 illustrated in FIG. 1 according to the embodiment is, for example, an inkjet printer that prints an image such as a character or a photograph by ejecting ink, which is an example of a liquid, onto a medium such as paper or fabric.

### Liquid Ejection Apparatus 11

In the liquid ejection apparatus 11 illustrated in FIG. 1, three directions intersecting (for example, orthogonal to) each other are indicated by an XYZ coordinate system, and are respectively defined as an X direction, a Y direction, and a Z direction. The X direction and the Y direction intersect (for example, are orthogonal to) each other in a horizontal plane, for example. Since the X direction is a scanning direction in which a liquid ejection unit 22 moves in the liquid ejection apparatus 11, the X direction is also referred to as a scanning direction X. The X direction is also a direction in which a medium 99 as a portion, on which printing is performed by the liquid ejection unit 22 ejecting the liquid, is conveyed. The Y direction is a direction intersecting (for example, orthogonal to) the scanning direction X in a horizontal plane. Since the Z direction is a direction parallel to a vertical direction, the Z direction is also referred to as a vertical direction Z. The vertical direction Z includes an upward direction +Z and a downward direction −Z.

As illustrated in FIG. 1, the liquid ejection apparatus 11 includes a housing 12. The liquid ejection apparatus 11 includes a medium feeding part 13. The medium feeding part 13 is configured to feed the medium 99. The medium feeding part 13 is accommodated in the housing 12, for example. The medium feeding part 13 includes a feeding shaft 14. The feeding shaft 14 rotatably holds a roll body 90 on which the medium 99 is wound and stacked. The feeding shaft 14 holds the medium 99 before printing. As the feeding shaft 14 rotates, the medium 99 is fed from the medium feeding part 13. The feeding shaft 14 may be driven and rotated by a motor or may be driven and rotated as the medium 99 is pulled.

The liquid ejection apparatus 11 includes a medium winding part 15. The medium winding part 15 is configured to wind up the medium 99. The medium winding part 15 is accommodated in the housing 12, for example. The medium winding part 15 includes a winding shaft 16. The winding shaft 16 rotatably holds the roll body 90 similarly to the feeding shaft 14. The winding shaft 16 holds the medium 99 after printing. As the winding shaft 16 rotates, the medium winding part 15 winds up the medium 99. For example, the winding shaft 16 is driven and rotated by a motor.

The liquid ejection apparatus 11 includes a medium support 17. The medium support 17 supports the medium 99. The medium support 17 is accommodated in the housing 12, for example. The medium support 17 supports the medium 99 from below, for example. The medium support 17 supports the medium 99 in a process from when the medium 99 is fed from the medium feeding part 13 to when the medium 99 is wound up around the medium winding part 15. Printing is performed on a region of the medium 99 that is a region supported by the medium support 17.

The medium support 17 may be, for example, a platen having a rectangular parallelepiped shape extending in the scanning direction X. The platen may include a plurality of ribs that support the medium 99. The platen may include an absorbing member capable of absorbing a liquid such as ink ejected from a liquid ejection head 23 to a place other than the medium 99.

The liquid ejection apparatus 11 includes a conveyance unit 18. The conveyance unit 18 is configured to convey the medium 99. The conveyance unit 18 is accommodated in the housing 12, for example. The conveyance unit 18 conveys the medium 99 from the medium feeding part 13 toward the medium winding part 15. For example, the conveyance unit 18 conveys the medium 99 in a forward movement direction A1 on the medium support 17. For example, the conveyance unit 18 intermittently conveys the medium 99. Specifically, the conveyance unit 18 stops when the liquid is being ejected onto a region of the medium 99 that is the region supported by the medium support 17. The conveyance unit 18 conveys the medium 99 after the liquid is ejected onto the region of the medium 99 that is the region supported by the medium support 17. The conveyance unit 18 may convey not only the continuous elongated medium 99 but also the single-sheet medium 99 from the roll body 90.

The conveyance unit 18 includes one or more conveyance rollers 19. The one or more conveyance rollers 19 are located in the housing 12, for example. The one or more conveyance rollers 19 rotate to convey the medium 99. The medium 99 is wound around the one or more conveyance rollers 19. The one or more conveyance rollers 19 may sandwich the medium 99. When the one or more conveyance rollers 19 rotate, the medium 99 is conveyed. Each conveyance roller 19 includes, for example, a roller driven and rotated by a motor. A conveyance path of the medium 99 is formed in the housing 12 by the one or more conveyance rollers 19.

The liquid ejection apparatus 11 includes a drying unit 21. The drying unit 21 is configured to dry the medium 99 after printing. The drying unit 21 dries the medium 99 in a process in which the medium 99 is conveyed from the medium support 17 to the medium winding part 15. For example, the drying unit 21 is located in the housing 12. For example, the drying unit 21 is located directly below the medium support 17. The drying unit 21 may include a heater that heats the medium 99. The drying unit 21 may include a blower that blows a gas onto the medium 99.

The liquid ejection apparatus 11 includes the liquid ejection unit 22. The liquid ejection unit 22 is configured to eject a liquid. The liquid ejection unit 22 ejects the liquid onto the medium 99. The liquid ejection unit 22 includes the liquid ejection head 23. The liquid ejection head 23 includes a plurality of nozzles 24. The liquid ejection head 23 has a nozzle surface 25 that can face a support surface (for example, an upper surface) of the medium support 17. One or more nozzles 24 are opened in the nozzle surface 25. The number of nozzles 24 may be two or more.

The liquid ejection unit 22 of the embodiment reciprocates in the scanning direction X. The liquid ejection unit 22 includes a carriage 26 configured to reciprocate in the scanning direction X. The liquid ejection head 23 is mounted on the carriage 26. The liquid ejection unit 22 passes through a position facing the medium support 17 when reciprocating in the scanning direction X. For example, the liquid ejection unit 22 is located above the medium support 17.

The scanning direction X includes the forward movement direction A1 and a backward movement direction A2. The backward movement direction A2 is a direction opposite to the forward movement direction A1. In the liquid ejection apparatus 11, the direction in which the carriage 26 moves coincides with the direction in which the medium 99 moves on the medium support 17. Therefore, the liquid ejection apparatus 11 is a lateral printer. In the case of a lateral printer, the carriage 26 may also be movable in a sub-scanning direction Y orthogonal to the scanning direction X (main scanning direction X). The liquid ejection apparatus 11 may be a serial printer in which the medium 99 is conveyed in a direction different from the scanning direction X. The liquid ejection apparatus 11 may be a serial printer in which a direction different from the X direction in which the medium 99 is conveyed is a scanning direction in which the carriage 26 moves.

As illustrated in FIG. 1, the liquid ejection unit 22 performs printing on the medium 99 by ejecting a liquid onto the medium 99. The liquid ejection unit 22 ejects the liquid from one or more nozzles 24 opened in the nozzle surface 25. The liquid ejection unit 22 may eject the liquid from a plurality of nozzles 24.

The liquid ejection unit 22 reciprocates in the scanning direction X together with the carriage 26. Accordingly, the liquid ejection unit 22 can eject the liquid over the entire region of the medium 99 that is the region supported by the medium support 17.

The liquid ejection unit 22 is displaced to a plurality of positions by moving in the scanning direction X. The liquid ejection unit 22 is displaced not only to a position facing the medium support 17 but also to a position not facing the medium support 17. The liquid ejection unit 22 may reciprocate at the position facing the medium support 17 during printing, or may reciprocate to the position not facing the medium support 17 in an operation different from printing.

As illustrated in FIG. 1, the liquid ejection apparatus 11 includes a pressurizing unit 28. The pressurizing unit 28 is configured to pressurize the inside of the liquid ejection unit 22. The pressurizing unit 28 is coupled to the liquid ejection unit 22. The pressurizing unit 28 is, for example, a pump. The pressurizing unit 28 supplies, by pressurization, the liquid to a flow path (not illustrated) communicating with the nozzles 24. The liquid ejection unit 22 is coupled to a liquid supply source (not illustrated) such as an ink cartridge or an ink tank through a flow path. The pressurizing unit 28 supplies, by pressurization, the liquid at an amount consumed by the liquid ejection unit 22 ejecting the liquid from the nozzles 24, from the liquid supply source to a flow path (not illustrated) communicating with the nozzles 24.

The flow path pressurized by the pressurizing unit 28 may be a circulation flow path passing through the liquid ejection unit 22. In this case, the pressurizing unit 28 may perform a circulation operation of circulating the liquid in the circulation flow path. The liquid such as ink contains a coloring matter. The coloring matter is, for example, a pigment or a dye. Depending on the type of liquid, the coloring matter (for example, a pigment) may easily precipitate over time. When the liquid in which the coloring matter easily precipitates is used, a circulation operation of circulating the liquid through the circulation flow path may be performed. The coloring matter in the liquid is stirred by the circulation operation, and thus the precipitation of the coloring matter is restricted.

The liquid ejection apparatus 11 includes a maintenance unit 30. The maintenance unit 30 is used in the liquid ejection apparatus 11 including the liquid ejection unit 22. The maintenance unit 30 performs maintenance on the liquid ejection unit 22. The maintenance is reception of the liquid discharged or ejected from the nozzles 24 at a maintenance timing. The maintenance unit 30 of the embodiment includes a liquid receiving portion 31 that receives the liquid discharged or ejected from the nozzles 24 during cleaning or flushing of the liquid ejection unit 22. The liquid receiving portion 31 receives the liquid discharged or ejected from the nozzles 24 as maintenance in order for the liquid ejection unit 22 to prevent or eliminate an ejection failure (clogging or the like) of the nozzles 24.

The liquid ejection unit 22 may perform cleaning of forcibly discharging the liquid from the nozzles 24. In addition, the liquid ejection unit 22 may perform flushing (dummy ejection) of ejecting a liquid not related to printing from the nozzles 24. Here, the flushing is processing of ejecting droplets that are not related to printing from all of the nozzles 24.

The liquid ejection unit 22 moves to a discharge position EP at a cleaning timing. The discharge position EP is, for example, a position located in the backward movement direction A2 of the position facing the medium support 17. The liquid ejection unit 22 forcibly discharges the liquid from the nozzles 24 toward the maintenance unit 30 at the discharge position EP. The maintenance unit 30 receives the liquid discharged from the nozzles 24. Further, the liquid ejection unit 22 moves to the discharge position EP at a flushing timing. The liquid ejection unit 22 ejects the liquid from the nozzles 24 toward the maintenance unit 30 at the discharge position EP. By the cleaning, for example, air bubbles, foreign matters, and the like present in the liquid in the nozzles 24 are discharged together with the liquid (ink). In the case of flushing, for example, a thickened liquid (thickened ink) present in the liquid in the nozzles 24 is discharged from the nozzles 24 by ejection. In this way, the ejection failure of the nozzles 24 is prevented or eliminated by the cleaning or flushing.

When the liquid ejection unit 22 is configured to eject droplets of a plurality of sizes from the nozzles 24, the size of the droplets ejected from the nozzles 24 during the flushing may be, for example, the largest size. By ejecting droplets having a large size from the nozzles 24 during the flushing, it is possible to effectively restrict the occurrence of ejection failure even with a relatively small number of times of ejection.

The liquid ejection apparatus 11 includes a wiping part 40. The wiping part 40 wipes the nozzle surface 25 by coming into contact with the nozzle surface 25. When the wiping part 40 wipes the nozzle surface 25, the liquid adhering to the nozzle surface 25 is removed. That is, the wiping part 40 performs wiping on the liquid ejection unit 22. For example, the wiping part 40 wipes the nozzle surface 25 after the cleaning. When the cleaning is performed, the liquid adheres to the nozzle surface 25 as the liquid is discharged from the nozzles 24. Therefore, the wiping part 40 may wipe the nozzle surface 25 after the cleaning. Accordingly, the liquid adhering to the nozzle surface 25 is removed.

The liquid ejection unit 22 is displaced to a wiping position WP facing the wiping part 40. The wiping position WP is a position where the liquid adhering to the nozzle surface 25 is removed. The wiping position WP is, for example, a position shifted in the backward movement direction A2 from the position where the liquid ejection unit 22 faces the medium support 17.

The wiping part 40 is aligned with the maintenance unit 30 in the scanning direction X, for example. In one example, the wiping part 40 is disposed at a position shifted from the maintenance unit 30 in the backward movement direction A2. For example, when the liquid ejection unit 22 is located at the wiping position WP, the liquid ejection unit 22 faces the wiping part 40. For example, the wiping part 40 comes into contact with the nozzle surface 25 when approaching the liquid ejection unit 22 located at the wiping position WP. The wiping part 40 may come into contact with the nozzle surface 25 when the liquid ejection unit 22 located at the wiping position WP approaches the wiping part 40. The wiping part 40 wipes the nozzle surface 25 by moving relative to the liquid ejection unit 22 in a direction along the nozzle surface 25 while being in contact with the nozzle surface 25.

The liquid ejection apparatus 11 includes a capping part 45. The capping part 45 moisturizes the nozzles 24 by coming into contact with the nozzle surface 25. The capping part 45 includes, for example, a cap 45C. The capping part 45 forms a substantially closed space communicating with the nozzles 24 by coming into contact with the nozzle surface 25. That is, the capping part 45 performs capping on the liquid ejection unit 22. The nozzles 24 are moisturized by the capping. As a result, the possibility of clogging of the nozzles 24 is reduced.

The liquid ejection unit 22 may stand by at a retracted position CP facing the capping part 45 until printing is started. In this standby state, the liquid ejection unit 22 is displaced to the retracted position CP facing the capping part 45. The retracted position CP is a position where the liquid ejection unit 22 stops when printing is not performed, for example, when input of a start signal of a print job is waited. The liquid ejection unit 22 stands by at the retracted position CP when printing is not performed. That is, the retracted position CP is a home position of the liquid ejection unit 22. The retracted position CP is, for example, a position shifted in the backward movement direction A2 from the position facing the medium support 17. When printing is started, for example, when a start signal of a print job is input, the liquid ejection unit 22 is displaced in the forward movement direction A1 from the retracted position CP toward the position of the medium support 17.

The liquid ejection unit 22 reciprocates in the scanning direction X. The medium support 17 is disposed at a position shifted from the maintenance unit 30, the wiping part 40, and the capping part 45 in the forward movement direction A1. During printing, the liquid ejection unit 22 moves in the forward movement direction A1 from the retracted position CP. The liquid ejection unit 22 moves in the forward movement direction A1 and the backward movement direction A2 within a range of the position facing the medium support 17. For example, the liquid ejection unit 22 performs printing on a portion of the medium 99 supported by the medium support 17 by ejecting droplets of ink or the like from the nozzles 24 in the process of reciprocating within the range facing the medium support 17.

As illustrated in FIG. 1, the liquid ejection apparatus 11 includes a control unit 100. The control unit 100 controls the liquid ejection apparatus 11. The control unit 100 may include one or more processors that execute various types of processing according to a computer program. The control unit 100 may include one or more dedicated hardware circuits, for example, ASICs that execute at least part of the various types of processing. The control unit 100 may include a circuit including a combination of a processor and a hardware circuit. The processor includes a CPU and a memory such as a RAM and a ROM. The memory stores program codes or commands configured to cause the CPU to execute processing. The memory, that is, a computer-readable medium includes any readable medium accessible by a general-purpose or dedicated computer.

The control unit 100 controls, for example, the medium feeding part 13, the medium winding part 15, the conveyance unit 18, the drying unit 21, the liquid ejection unit 22, the pressurizing unit 28, the maintenance unit 30, the wiping part 40, the capping part 45, and the like.

The control unit 100 may control the pressurizing unit 28 to execute, at predetermined time intervals, the circulation operation of circulating the liquid in the circulation flow path passing through the liquid ejection unit 22. By the circulation operation, the precipitation of the coloring matter (for example, a pigment) in the liquid is effectively eliminated. The control unit 100 may execute the circulation operation after the printing is completed. Accordingly, the next printing is smoothly executed. The control unit 100 may execute the circulation operation when the power of the liquid ejection apparatus 11 is turned on from off. When the power is turned on from off, the liquid is often stagnant for a long time. Therefore, the coloring matter precipitated in the liquid can be stirred by the circulation operation. The control unit 100 may change duration of the circulation operation or a circulation intensity.

The control unit 100 may receive a print job from a host device (not illustrated), which is an example of an external device. The host device may be, for example, a personal computer. The liquid ejection apparatus 11 may include an operation panel. A user may operate an operation unit of the operation panel to transmit the print job to the control unit 100. The control unit 100 executes the received print job.

A linear encoder (not illustrated) for detecting the position of the liquid ejection unit 22 (carriage 26) in the scanning direction X is provided in the housing 12. The linear encoder outputs a detection signal including a number of pulses proportional to a movement amount of the liquid ejection unit 22 in the scanning direction X. The control unit 100 counts the number of pulse edges of the detection signal received from the linear encoder with a counter (not illustrated). The counter is reset when the liquid ejection unit 22 is located at an origin position in the scanning direction X. The control unit 100 acquires the position of the liquid ejection unit 22 from a count value of the counter. The control unit 100 performs position control and speed control for the liquid ejection unit 22 based on the detection signal from the linear encoder and the count value of the counter. The control unit 100 performs printing on the medium 99, movement to each of the positions EP, WP, and CP, and the like by performing the position control and the speed control for the liquid ejection unit 22.

### Configuration of Liquid Ejection Unit 22

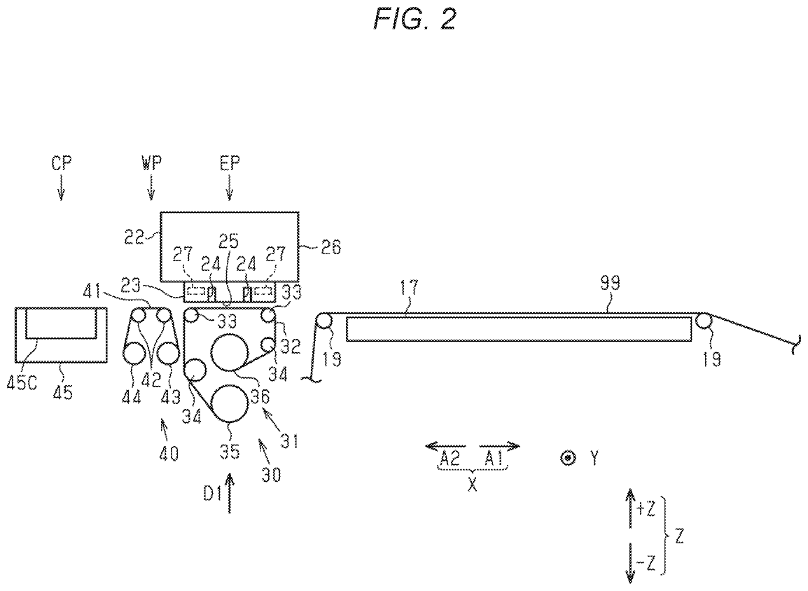

A detailed configuration of the liquid ejection unit 22 will be described with reference to FIG. 2. As illustrated in FIG. 2, the liquid ejection unit 22 includes one or more piezoelectric elements 27. The liquid ejection unit 22 may include a plurality of piezoelectric elements 27. The liquid ejection unit 22 may include the same number of piezoelectric elements 27 as the nozzles 24. The piezoelectric element 27 changes a pressure in the nozzle 24 when applied with a voltage. When the piezoelectric element 27 changes the pressure in the nozzle 24, the liquid is ejected from the nozzle 24. Specifically, the piezoelectric element 27 includes a piezoelectric body and a diaphragm. The diaphragm constitutes a part of a surface portion that defines a pressure chamber communicating with the nozzle 24. When a voltage is applied to the piezoelectric element 27, the diaphragm vibrates due to the electrostrictive action of the piezoelectric body. The pressure chamber is deformed with expansion and contraction by the vibration of the diaphragm, whereby the liquid such as ink is ejected from the nozzle 24.

The piezoelectric element 27 can change the pressure in the nozzle 24 so as not to eject the liquid from the nozzle 24. That is, by adjusting the voltage applied to the piezoelectric element 27 to such a magnitude that the liquid is not ejected, it is also possible to cause the piezoelectric element 27 to slightly vibrate with such a strength that the liquid in the nozzle 24 is not ejected. The liquid in the nozzle 24 is stirred by the slight vibration. As a result, the thickening of the liquid in the nozzle 24 is eliminated. The liquid ejection unit 22 appropriately performs the slight vibration, for example, before printing or during printing. The slight vibration is performed in a state where the liquid ejection unit 22 is stopped.

The liquid ejection unit 22 may be capable of adjusting the size of droplets of the liquid ejected from the nozzle 24. The voltage applied to the piezoelectric element 27 may be adjustable in a plurality of levels within a range of voltages at which the liquid can be ejected. The size of droplets ejected from the nozzle 24 may be adjusted by adjusting the voltage applied to the piezoelectric element 27. In this case, the size of droplets ejected from the nozzle 24 during printing may be adjusted according to a print resolution, an image color, or the like.

In FIG. 2, two nozzles 24 at different positions in the scanning direction X are schematically illustrated. The nozzles 24 may include M (M being a natural number) nozzles 24 at different positions in the scanning direction X. M may be equal to the number of colors of the liquid (for example, ink) ejected from the nozzle 24 by the liquid ejection unit 22. When the number of colors is one, M may be 1. For example, in the case of a configuration capable of color printing, the number of colors may be three or more including cyan, magenta, and yellow. In this case, the number M of nozzles 24 at different positions in the scanning direction X may be three or more (M≥3). For example, the number of colors may be four, namely cyan, magenta, yellow, and black, and the number M of nozzles 24 at different positions in the scanning direction X may be four (M=4). M may be 2.

The liquid ejection unit 22 ejects the liquid onto a region of the medium 99 that is the region supported by the medium support 17. The liquid ejection unit 22 is, for example, a line head capable of simultaneously ejecting the liquid over the width of the medium 99. In this case, the line head may be implemented by one elongated liquid ejection head 23 elongated in the Y direction. Alternatively, the line head may be implemented by using one liquid ejection head 23 as a unit head and arranging a plurality of liquid ejection heads 23 as unit heads in the Y direction.

A plurality of nozzles 24 are arranged at a predetermined nozzle pitch in the Y direction orthogonal to the scanning direction X to form one nozzle row. The number of nozzles 24 per nozzle row in the line head may be, for example, a value within a range from 1000 to 10000. In the example of the liquid ejection head 23 as a unit head, the number of nozzles 24 per nozzle row in the unit head is, for example, a value within a range from 200 to 1000. The line head may be implemented by arranging the unit heads at a predetermined number within a range from 2 to 20, for example. As described above, when the liquid ejection unit 22 is a line head, the nozzle surface 25 has a length equal to or longer than the width of the medium 99 in the Y direction. The liquid ejection unit 22 formed of the line head has an elongated shape and is longer in the Y direction than in the scanning direction X. When the liquid ejection unit 22 is a serial head, the nozzle row of the liquid ejection unit 22 is formed by arranging the nozzles 24 at a predetermined nozzle pitch in a conveyance direction of the medium 99. In this case, a plurality of nozzle rows are arranged in the Y direction.

### Configurations of Maintenance Unit 30, Wiping Part 40, and Capping Part 45

Next, configurations of the maintenance unit 30, the wiping part 40, and the capping part 45 will be described in detail with reference to FIG. 2.

The maintenance unit 30 includes the liquid receiving portion 31. The maintenance unit 30 has a function of moving the liquid receiving portion 31 in a first direction D1 toward the liquid ejection unit 22. The maintenance unit 30 has a moving function of moving the liquid receiving portion 31 in the first direction D1 and a positioning function of positioning the liquid receiving portion 31, which is moved in the first direction D1, with respect to the nozzle surface 25 of the liquid ejection unit 22.

The liquid receiving portion 31 includes cloth 32 that functions as a liquid receiving member configured to receive the liquid discharged or ejected from the nozzles 24 of the liquid ejection unit 22 for the cleaning or flushing. The cloth 32 is a member that absorbs the received liquid. The cloth 32 receives and absorbs the liquid discharged or ejected from the nozzles 24. The amount of liquid ejected to the liquid receiving portion 31 by the flushing is smaller than the amount of liquid discharged to the liquid receiving portion 31 by the cleaning. The liquid receiving portion 31 may receive the liquid from the nozzles 24 for only one of the cleaning and the flushing.

The maintenance unit 30 is aligned with the medium support 17 in the scanning direction X, for example. In one example, the maintenance unit 30 is located in the backward movement direction A2 with respect to the medium support 17. The maintenance unit 30 receives the liquid discharged from the liquid ejection unit 22 when the liquid ejection unit 22 is located at a position facing the maintenance unit 30. Specifically, when the liquid ejection unit 22 is located at the discharge position EP, the maintenance unit 30 receives the liquid discharged from the liquid ejection unit 22. The discharge position EP is a position where the liquid ejection unit 22 faces the maintenance unit 30.

The flushing may be performed in a state where the liquid ejection unit 22 stops at the discharge position EP. The flushing may be performed in a state where the liquid ejection unit 22 is moving in the forward movement direction A1 during printing. That is, the flushing may be performed while the liquid ejection unit 22 is passing through the discharge position EP during printing.

As illustrated in FIG. 2, the liquid receiving portion 31 includes, for example, a pair of holding rollers 33 and one or a plurality of guide rollers 34. The cloth 32 is wound around the pair of holding rollers 33. The pair of holding rollers 33 hold the cloth 32. A region of the cloth 32 held between the pair of holding rollers 33 faces the nozzle surface 25. The cloth 32 receives the liquid ejected or discharged to the region. The guide roller 34 guides the cloth 32 together with the pair of holding rollers 33. Accordingly, the cloth 32 is guided along a predetermined feed path.

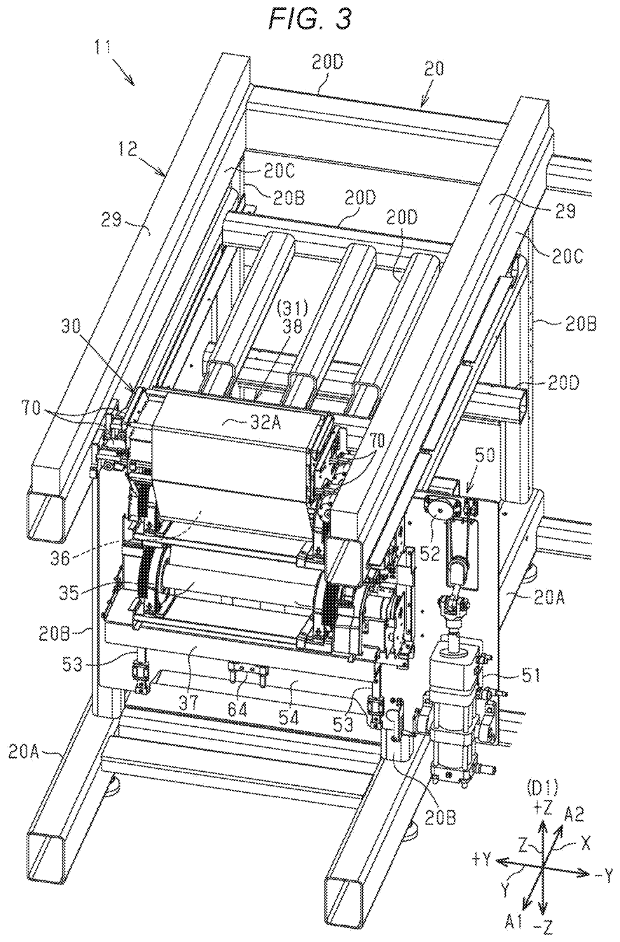

The liquid receiving portion 31 includes a feeding part 35 and a winding part 36. The feeding part 35 supplies the unused cloth 32 by feeding the cloth 32. The winding part 36 collects the used cloth 32 by winding up the cloth 32. For example, the feeding part 35 and the winding part 36 rotate every time the cloth 32 receives a certain amount of liquid. Specifically, the control unit 100 controls a feed amount of the cloth 32 by controlling the maintenance unit 30. The liquid ejection unit 22 moves to the discharge position EP at a timing when the cleaning or the flushing is necessary. The liquid ejection unit 22 ejects the liquid from all the nozzles 24 toward the cloth 32 at the discharge position EP. The maintenance unit 30 can be moved (for example, lifted and lowered) for replacing the liquid receiving portion 31. The maintenance unit 30 includes a movement mechanism 50 (see FIG. 3) that moves the replaced liquid receiving portion 31 to the maintenance position. With the movement mechanism 50, the liquid receiving portion 31 is disposed at the maintenance position facing the nozzle surface 25 of the liquid ejection unit 22 with a specified distance therebetween.

The control unit 100 performs feed control of feeding the cloth 32 of the liquid receiving portion 31. The control unit 100 manages the amount of liquid discharged by the liquid ejection unit 22 in the cleaning or the amount of liquid ejected in the flushing. That is, the control unit 100 manages a liquid receiving amount indicating the amount of liquid received by the cloth 32 of the liquid receiving portion 31 in the liquid receiving region. When the liquid receiving amount exceeds a predetermined threshold, the control unit 100 drives the winding part 36 to feed the cloth 32 by a predetermined feed amount, thereby updating the cloth 32 in the liquid receiving region to the new cloth 32. When the winding part 36 winds up the cloth 32 by the predetermined feed amount, the cloth 32 of the same feed amount is fed from the feeding part 35 by a winding force. In this way, the cloth 32 is intermittently fed at each predetermined timing at which the liquid receiving amount of the liquid receiving region exceeds the threshold, and thus the used cloth 32 in the liquid receiving region is updated to the unused cloth 32.

A time interval between cleaning timings is considerably longer than a time interval between flushing timings. The control unit 100 may determine the cleaning timing according to a print length that is a length of the medium 99 printed from the previous cleaning execution time-point or a print time that is the time over which printing is performed on the medium 99. The control unit 100 may manage only one of the print length and the print time. Further, the control unit 100 may determine the flushing timing according to an elapsed time from the previous flushing execution time-point. The elapsed time for determining the flushing timing may be, for example, a predetermined value within a range of 10 seconds to 30 seconds. When the medium 99 is a single-sheet medium such as single sheet paper, the control unit 100 may manage the number of printed sheets instead of the print length. In this case, the control unit 100 may set, as the cleaning timing, a time when the number of printed sheets reaches a predetermined threshold.

The wiping part 40 includes a wiping portion 41. The wiping portion 41 is a member that comes into contact with the nozzle surface 25. The wiping portion 41 is, for example, cloth. The wiping part 40 is movable to the retracted position where the wiping portion 41 is separated from the nozzle surface 25 and the wiping position where the wiping portion 41 can wipe the nozzle surface 25. By moving in the first direction D1 from the retracted position toward the nozzle surface 25, the wiping part 40 is disposed at the wiping position where the wiping portion 41 can wipe the nozzle surface 25.

The wiping part 40 includes, for example, one or more pressing rollers 42. The pressing roller 42 is a roller that presses the wiping portion 41 against the nozzle surface 25. Accordingly, the wiping portion 41 can come into close contact with the nozzle surface 25. The wiping portion 41 wipes the nozzle surface 25 to remove the liquid adhering to the nozzle surface 25. The wiping portion 41 absorbs the liquid removed from the nozzle surface 25. The wiping part 40 includes, for example, a feeding part 43 and a winding part 44. The feeding part 43 feeds unused cloth to the wiping portion 41, and the winding part 44 winds up used cloth from the wiping portion 41. Accordingly, the cloth of the wiping portion 41 is updated to unused cloth. For example, the feeding part 43 and the winding part 44 rotate every time the wiping portion 41 wipes the nozzle surface 25 a predetermined number of times. At least one of the feeding part 43 and the winding part 44 includes a drive unit as a drive source.

The capping part 45 is aligned with the wiping part 40 in the scanning direction X, for example. In one example, the capping part 45 is disposed at a position shifted from the wiping part 40 in the backward movement direction A2. The capping part 45 faces the nozzle surface 25, for example, when the liquid ejection unit 22 is located at the retracted position CP. The capping part 45 includes, for example, the cap 45C that can come into contact with the nozzle surface 25. By moving the capping part 45 in the first direction D1 toward the liquid ejection unit 22, the cap 45C comes into contact with the nozzle surface 25. The cap 45C may come into contact with the nozzle surface 25 by moving the liquid ejection unit 22 toward the capping part 45 in a direction −D1 opposite to the first direction D1.

The cap 45C forms a substantially closed space communicating with the nozzles 24 between the nozzle surface 25 and the cap 45C by coming into contact with the nozzle surface 25. When the liquid ejection unit 22 is capped by the cap 45C, the nozzles 24 communicating with the substantially closed space surrounded by the nozzle surface 25 and the cap 45C are moisturized. The moisturizing effect restricts thickening and drying of the liquid in the nozzles 24. For example, an absorbing member (not illustrated) in which a moisturizing liquid is absorbed may be accommodated in the cap 45C. The moisturizing liquid may be a dedicated moisturizing liquid, or may be water that is a solvent component in a liquid such as ink ejected or discharged from the nozzles 24 of the liquid ejection unit 22.

Further, one of the cleaning and the flushing may be performed for the cap 45C. For example, the cleaning may be performed for the cap 45C. In this case, the cleaning may be, for example, pressurized cleaning in which the pressurizing unit 28 pressurizes the liquid ejection unit 22 to forcibly discharge the liquid from the nozzles 24. The cap 45C may be coupled to a waste liquid storage portion (not illustrated) through a discharge tube (not illustrated). For example, by driving a suction pump (not illustrated) provided in the middle of the discharge tube, the liquid (waste liquid) received by the cap 45C is collected in the waste liquid storage portion through the discharge tube. The cleaning may be suction cleaning performed by driving a suction pump in a capping state instead of the pressurized cleaning. In the suction cleaning, the substantially closed space surrounded and formed by the nozzle surface 25 and the cap 45C is set to a negative pressure by driving of the suction pump, so that the liquid is forcibly discharged from the nozzles 24.

For example, when performing the cleaning for the cap 45C, the maintenance unit 30 may receive only the liquid during the flushing. In addition, when performing the flushing for the cap 45C, the maintenance unit 30 may receive only the liquid during the cleaning.

When the liquid ejection unit 22 is a line head, the cloth 32 facing the nozzle surface 25 in the maintenance unit 30 has a length in the Y direction corresponding to the nozzle surface 25 having an elongated shape elongated in the Y direction. Similarly, the wiping portion 41 of the wiping part 40 has a length in the Y direction corresponding to the nozzle surface 25 having an elongated shape elongated in the Y direction. The cap 45C of the capping part 45 also has a length in the Y direction corresponding to the nozzle surface 25 having an elongated shape elongated in the Y direction. The liquid ejection unit 22 may have a configuration in which a plurality of nozzle rows extending in a direction intersecting the scanning direction X at an acute angle are arranged in the Y direction, and thus the nozzles 24 capable of ejecting a liquid of one predetermined color are arranged in the Y direction at a predetermined nozzle pitch. In this case, a plurality of caps 45C arranged in the Y direction may cap the nozzle surface 25. In FIG. 2, only some of the main components of the maintenance unit 30 are shown, and the overall configuration will be described in detail later.

### Configuration of Maintenance Unit 30

Next, a detailed configuration of the maintenance unit 30 will be described with reference to FIGS. 3 to 8. FIG. 3 is a perspective view of the maintenance unit 30 as viewed obliquely from above. The Y direction includes a +Y direction and a −Y direction. The +Y direction is a direction from a back surface to a front surface of the liquid ejection apparatus 11, and the −Y direction is a direction from the front surface to the back surface of the liquid ejection apparatus 11.

As illustrated in FIG. 3, the liquid ejection apparatus 11 includes a body frame 20 constituting the housing 12. The body frame 20 includes a bottom member 20A, a column member 20B, an upper member 20C, and a beam member 20D. Each of the members 20A to 20D is formed of, for example, a square pipe. The body frame 20 has a column-beam structure in which the members 20A to 20D are assembled. The upper member 20C extends in the scanning direction X. A scanning rail 29 extending in the scanning direction X is fixed to upper surfaces of two upper members 20C. The liquid ejection unit 22 (see FIG. 2) moves in the scanning direction X by being guided by the two scanning rails 29. A height of the liquid ejection unit 22 is defined by a height of an upper surface of the body frame 20 to which the scanning rails 29 are fixed.

As illustrated in FIG. 3, the maintenance unit 30 includes a maintenance part 38, the movement mechanism 50, and a positioning part 70. The maintenance part 38 is disposed below a movement path of the liquid ejection unit 22 (see FIG. 2) that moves in the scanning direction X along the scanning rails 29. The maintenance part 38 performs maintenance on the liquid ejection unit 22 (see FIG. 2) located at the discharge position EP. The maintenance part 38 is formed of the liquid receiving portion 31 that receives the liquid ejected or discharged from the liquid ejection unit 22. The maintenance part 38 is disposed in a region between two upper members 20C to which the two scanning rails 29 are fixed. The liquid ejection unit 22 stopped at the discharge position EP faces a facing portion 32A forming an upper surface of the maintenance part 38 in the first direction D1. The facing portion 32A is a liquid receiving region where the cloth 32 faces the nozzle surface 25 of the liquid ejection unit 22. The facing portion 32A is located on an uppermost surface in a movement path of the cloth 32 from being fed from the feeding part 35 up to being wound up around the winding part 36.

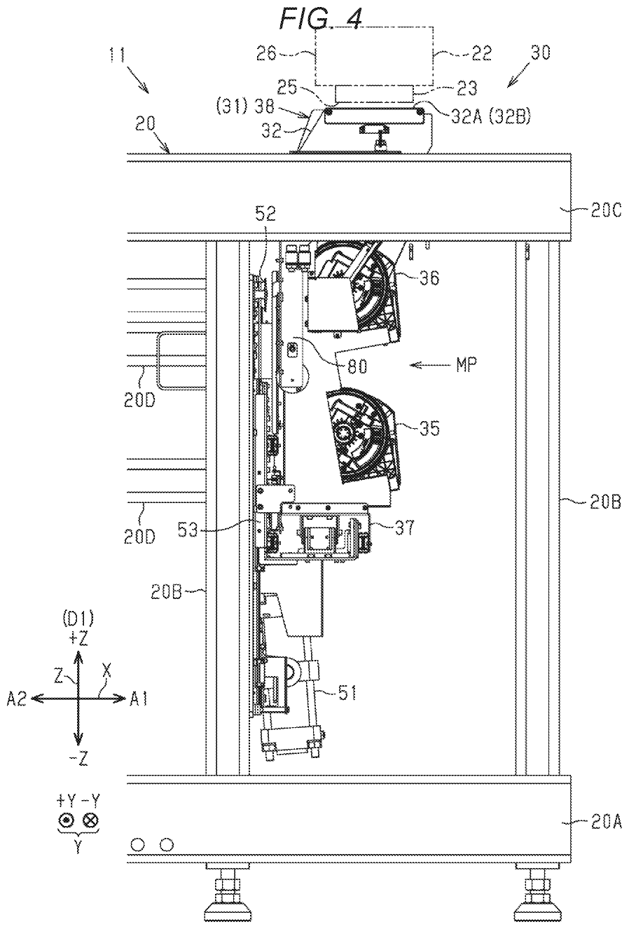

The maintenance part 38 is positioned at the maintenance position MP (see FIG. 4) by the movement mechanism 50 and the positioning part 70. In a state where the maintenance part 38 is positioned at the maintenance position MP, the facing portion 32A faces the nozzle surface 25 (see FIG. 2) of the liquid ejection unit 22 at a specified distance.

The movement mechanism 50 illustrated in FIG. 3 moves the maintenance part 38 in the first direction D1 toward the liquid ejection unit 22 (see FIG. 2). The movement mechanism 50 includes a drive unit 51 and a movable stand 37 that is movable in the first direction D1 by power of the drive unit 51. The maintenance part 38 is disposed on the movable stand 37. Therefore, by the power of the drive unit 51, the maintenance part 38 moves in the first direction D1 while being placed on the movable stand 37. The first direction D1 is a direction in which the maintenance part 38 is moved toward the liquid ejection unit 22 located at the discharge position EP. The first direction D1 is the upward direction +Z in the embodiment. That is, the movement mechanism 50 of the embodiment is a lifting and lowering mechanism that lifts and lowers the maintenance part 38.

The movement mechanism 50 includes a power transmission mechanism 52 that transmits the power of the drive unit 51 to the movable stand 37. The drive unit 51 is, for example, a cylinder formed of an electric cylinder or a pneumatic cylinder. The movement mechanism 50 includes a pair of guide rails 53 that guide the movable stand 37 in a direction along the first direction D1. The maintenance part 38 moves in the first direction D1 together with the movable stand 37 when the movable stand 37 moves in the first direction D1 along the pair of guide rails 53. The movement mechanism 50 includes a second restricting portion 64 that restricts a lowered position of the movable stand 37 when the movable stand 37 is lowered. Hereinafter, the drive unit 51 is also referred to as a “first drive unit 51” in order to distinguish the drive unit 51 from a second drive unit 72 that is a drive unit of the positioning part 70 described later.

### Regarding Function and Position of Positioning Part 70

Here, the position of the positioning part 70 will be described. The positioning part 70 positions the maintenance part 38 by further moving the maintenance part 38, which is moved in the first direction D1 together with the movable stand 37 by the power of the first drive unit 51, to a positioning position in the first direction D1. A plurality of positioning parts 70 are provided. When the plurality of positioning parts 70 are projected in a direction parallel to the first direction D1 on an XY plane orthogonal to the first direction D1, projection positions thereof are different positions on the XY plane.

Here, the number of positioning parts 70 is N (N being a natural number). When the N positioning parts 70 are projected in a direction parallel to the first direction D1 on a virtual plane formed of an XY plane orthogonal to the first direction D1, the N projection positions are N different positions on the virtual plane. That is, the N projection positions are different in at least one of the X direction and the Y direction on the virtual plane, and three or more projection positions are not aligned on the same straight line on the virtual plane.

As illustrated in FIG. 3, in the embodiment, N is, for example, four. Four projection positions where the four positioning parts 70 are projected onto the virtual plane are positions that define a quadrangle having points (projection points) of the four projection positions as four vertices. The quadrangle is, for example, a rectangle. As described above, the four positioning parts 70 are arranged at four positions such that the four projection positions are the vertices of a quadrangle on the virtual plane. By positioning four engaging portions 81 by the four positioning parts 70, when the maintenance part 38 is positioned at the maintenance position MP, a liquid receiving surface 32B, which is the surface of the facing portion 32A, can be made parallel to the nozzle surface 25. A detailed configuration of the positioning part 70 will be described later.

### Regarding Maintenance Position MP

FIG. 4 illustrates a front surface of the maintenance unit 30 with the maintenance part 38 located at the maintenance position MP. In FIG. 4, the scanning rails 29 are omitted. The maintenance position MP illustrated in FIG. 4 indicates a height position of the maintenance part 38 positioned by the N positioning parts 70 described above. The maintenance position MP is the height position of the maintenance part 38 when the liquid ejection unit 22 ejects or discharges the liquid toward the facing portion 32A of the cloth 32.

As illustrated in FIG. 4, when the maintenance part 38 is located at the maintenance position MP, the facing portion 32A is located above the upper surface of the upper member 20C of the body frame 20. That is, an upper end including the facing portion 32A of the maintenance part 38 is located above the upper surface of the upper member 20C. The liquid ejection unit 22 guided by the scanning rails 29 (see FIG. 3) moves in the scanning direction X at the height position above the upper surface of the upper member 20C to which lower surfaces of the scanning rails 29 are fixed. The maintenance part 38 is positioned at the maintenance position MP such that the distance in the first direction D1 between the nozzle surface 25 of the liquid ejection unit 22 located at the discharge position EP in the scanning direction X and the facing portion 32A is a specified distance. That is, the maintenance part 38 is positioned at the maintenance position MP such that the distance between the liquid receiving surface 32B, which is the surface of the facing portion 32A, and the nozzle surface 25 is a specified distance.

The specified distance is, for example, a distance suitable for the flushing. When the liquid is ejected from the nozzles 24 (see FIG. 2) of the liquid ejection unit 22 in the flushing, mist is generated. As the distance between the liquid receiving surface 32B and the nozzle surface 25 becomes longer than the specified distance, the possibility that the mist floats without reaching the liquid receiving surface 32B is higher. The floating mist adheres to the nozzle surface 25. In addition, as the distance between the liquid receiving surface 32B and the nozzle surface 25 becomes shorter than the specified distance, the liquid ejected from the nozzle 24 in the flushing rebounds more when hitting the liquid receiving surface 32B. Rebounded droplets are likely to adhere to the nozzle surface 25. The liquid adhering to the nozzle surface 25 affects ejection performance of the liquid from the nozzles 24. For example, the liquid adhering to the periphery of the nozzles 24 comes into contact with the liquid ejected from the nozzle 24 and acts to deflect a flying direction of the liquid. In this case, a landing position of the ejected liquid deviates from an assumed position, and thus the printing accuracy decreases.

In addition, when the amount of liquid adhering to the nozzle surface 25 during the flushing is large, the liquid that spreads with wetting due to the mist adhering to the nozzle surface 25 by the subsequent printing or the like easily reaches the nozzles 24. The liquid reaching the nozzles 24 affects the meniscus of the liquid formed in the nozzles 24. The amount (size) of the liquid (droplet) ejected from the nozzles 24 is controlled on the premise that the meniscus in the nozzles 24 has a specified shape. When the liquid is ejected from the nozzles 24 in a state in which the meniscus does not have the specified shape, droplets having a size larger or smaller than an assumed size are ejected from the nozzles 24. In this case, a size of a dot landed on the medium 99 is different from the assumed size, causing a decrease in printing quality.

Therefore, it is important to maintain the distance between the liquid receiving surface 32B, which is the surface of the facing portion 32A, and the nozzle surface 25 within a specified distance range in order to maintain the printing quality at a certain level or higher. In the embodiment, the movement mechanism 50 and the positioning part 70 set the height position of the maintenance part 38 in the first direction D1 when the maintenance part 38 is disposed at the maintenance position MP, so that the distance between the facing portion 32A and the nozzle surface 25 is set to be within the specified distance range.

### Regarding Parallelism Between Nozzle Surface 25 and Liquid Receiving Surface 32B

Next, parallelism between the nozzle surface 25 and the liquid receiving surface 32B will be described. When the nozzle surface 25 and the liquid receiving surface 32B are not parallel to each other, distances to the liquid receiving surface 32B are different between the plurality of nozzles 24 located on the nozzle surface 25. In this case, there is a possibility that the distance to the liquid receiving surface 32B for some nozzles among all the nozzles 24 deviates from the specified distance range. The nozzles 24 that deviate from an appropriate condition of the distance may cause a decrease in printing quality due to the above-described various problems, that is, flight deflection, variation in dot size, and the like.

Therefore, the parallelism between the nozzle surface 25 and the liquid receiving surface 32B is secured so as to satisfy an appropriate condition of the distance from the liquid receiving surface 32B for all the nozzles 24 on the nozzle surface 25. The positioning part 70 positions the maintenance part 38 so as to secure the parallelism between the nozzle surface 25 and the liquid receiving surface 32B within a certain range.

Here, the liquid ejection unit 22 is positioned such that the nozzle surface 25 is maintained at predetermined levelness when the liquid ejection unit 22 is assembled to the body frame 20 via the scanning rails 29. For example, the liquid ejection unit 22 is assembled to the body frame 20 so as to ensure the parallelism within a certain range with respect to the medium support 17.

In the embodiment, the maintenance part 38 moved to the maintenance position MP is positioned by the positioning part 70 with respect to the nozzle surface 25 of the liquid ejection unit 22 assembled in this manner. The maintenance part 38 is positioned by the positioning part 70 such that the nozzle surface 25 and the liquid receiving surface 32B are in postures parallel to each other and the distance between the nozzle surface 25 and the liquid receiving surface 32B is within the specified distance range.

In the embodiment, the plurality of positioning parts 70 also determine the posture of the liquid receiving surface 32B so as to ensure the parallelism within a certain range with respect to the nozzle surface 25 by positioning a plurality of parts of the maintenance part 38. Therefore, the plurality of positioning parts 70 are arranged so as to satisfy the above-described condition of the projection position with respect to the XY plane. Other configurations of the positioning part 70 for ensuring the parallelism of the liquid receiving surface 32B with respect to the nozzle surface 25 will be described later.

### Detailed Configurations of Movement Mechanism 50 and Others

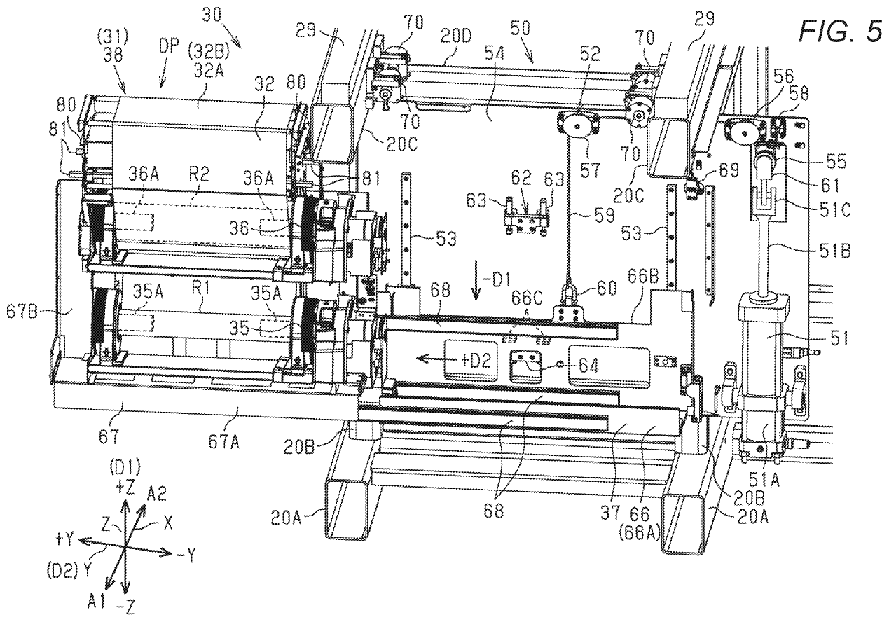

Next, a detailed configuration of the movement mechanism 50 will be described with reference to FIG. 5. FIG. 5 illustrates a state in which the maintenance part 38 is pulled out from the maintenance unit 30 to a work position DP.

As illustrated in FIG. 5, the movement mechanism 50 includes the first drive unit 51, the power transmission mechanism 52, the movable stand 37, the guide rails 53, a first restricting portion 62, and the second restricting portion 64 (FIGS. 3, 7, and 8). These components are assembled to an assembly plate 54. The assembly plate 54 is fixed to the two bottom members 20A, the two column members 20B, and the two upper members 20C, which constitute the body frame 20, such that a surface of the plate member is orthogonal to the scanning direction X.

The first drive unit 51 is a cylinder as described above, and includes a cylinder body 51A and a piston rod 51B. The piston rod 51B includes a coupling portion 51C at a tip end thereof. The first drive unit 51 formed of a cylinder performs driving by a predetermined stroke in a direction parallel to the first direction D1, for example.

The power transmission mechanism 52 is, for example, a wire type power transmission mechanism. The power transmission mechanism 52 includes a plurality of pulleys 55, 56, and 57, an end fitting 58, a wire rope 59, and a coupling fitting 60. A first end of the wire rope 59 is fixed to an end fitting 58 fixed to the assembly plate 54. A second end of the wire rope 59 is fixed to the coupling fitting 60 fixed to an upper portion of the movable stand 37. The wire rope 59 is wound around the plurality of pulleys 55, 56, and 57. In the embodiment, for example, three pulleys 55, 56, and 57 are provided. Both ends of the wire rope 59 are fixed to the end fitting 58 and the coupling fitting 60 via the three pulleys 55, 56, and 57.

The pulley 55 is, for example, a movable pulley. The pulley 55 is coupled to a tip end of the piston rod 51B. The piston rod 51B includes the coupling portion 51C at the tip end thereof. A holding member 61 is coupled to the coupling portion 51C. The pulley 55 is supported by the holding member 61. The holding member 61 is tiltable about an axis parallel to the Y direction with respect to the coupling portion 51C. The piston rod 51B expands and contracts with respect to the cylinder body 51A according to expansion and contraction drive of the first drive unit 51. The holding member 61 tilts according to the expansion and contraction of the piston rod 51B, whereby the pulley 55 is held in a state in which a change in posture is small.

The two pulleys 56 and 57 are fixed to the assembly plate 54 at different positions. The pulley 56 is disposed at a position where the pulley 55 can be suspended by the wire rope 59 between the pulley 56 and the end fitting 58. Therefore, the pulley 55 and the pulley 56 are disposed at positions where both outer peripheral portions around which the wire rope 59 is wound are in a positional relationship of being substantially adjacent to each other in a top view. The pulley 57 is disposed at a position where the movable stand 37 can be suspended by the wire rope 59. The pulley 57 is located above the coupling fitting 60. The coupling fitting 60 is fixed to, for example, a position near a center of the movable stand 37 in a width direction thereof. The fixing position of the coupling fitting 60 is, for example, a position where a weight balance of the movable stand 37 and the maintenance part 38 in the Y direction can be achieved.

The pulley 55 is a movable pulley whose position in the first direction D1 changes in accordance with expanding and contracting motions of the piston rod 51B when the drive unit 51 formed of a cylinder performs driving. The pulley 55 as a movable pulley is displaced in the first direction D1 by a movement amount equal to a movement amount of the piston rod 51B when the drive unit 51 performs driving. The movable stand 37 moves in a direction parallel to the first direction D1 by a movement amount about twice the movement amount of the pulley 55.

As illustrated in FIG. 5, the first restricting portion 62 is fixed at a predetermined height position in a substantially central portion of the assembly plate 54. The first restricting portion 62 includes one or more shock absorbers 63. The shock absorber 63 is attached in a posture in which a stopper portion thereof faces downward. Below the shock absorber 63, a restricting plate 66C extending horizontally from a back surface of the movable stand 37 is located. In the example illustrated in FIG. 5, two restricting plates 66C are located below two shock absorbers 63. The two shock absorbers 63 abut the two restricting plates 66C when the movable stand 37 is lifted, whereby the first restricting portion 62 restricts the position of the movable stand 37 when the movable stand 37 is lifted.

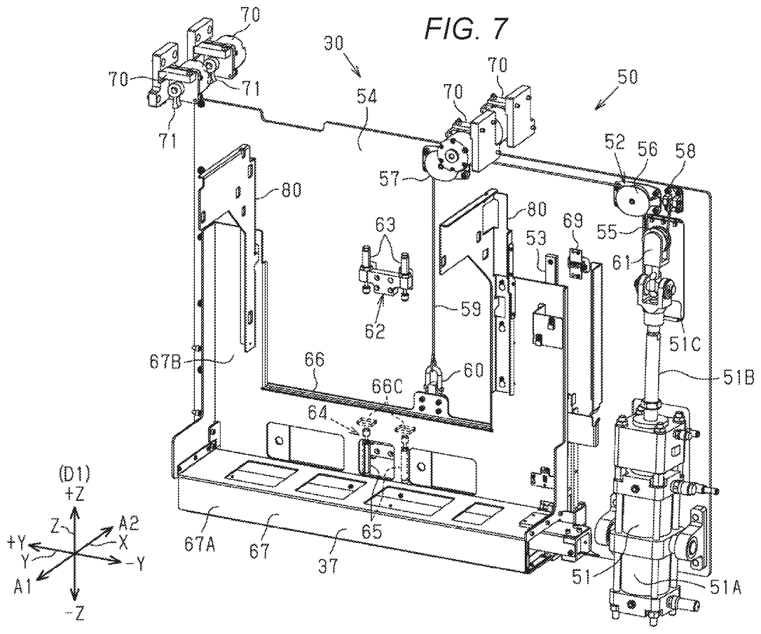

The second restricting portion 64 illustrated in FIG. 7 is fixed at a predetermined height position in a lower region of the assembly plate 54. The second restricting portion 64 includes one or more shock absorbers 65. The shock absorber 65 is attached in a posture in which a stopper portion thereof faces upward. Above the shock absorber 65, a restricting plate (not illustrated) extending horizontally from the back surface of the movable stand 37 is located. The restricting plate 66C may also serve as a restricting plate that the shock absorber 65 abuts when the movable stand 37 is lowered. Two shock absorbers 65 abut the two restricting plates 66C when the movable stand 37 is lowered, whereby the second restricting portion 64 restricts the position of the movable stand 37 when the movable stand 37 is lowered.

The movable stand 37 includes a base stand 66 and a slide stand 67. The base stand 66 includes a stand 66A and a back plate 66B. The coupling fitting 60 to which the wire rope 59 is fixed is fixed to, for example, the back plate 66B of the base stand 66. The back plate 66B is formed of a plate member that stands upright at a back surface of the base stand 66.

The movement mechanism 50 may include a slide rail 68 that allows the maintenance part 38 to move in a second direction +D2 orthogonal to the first direction D1. For example, the slide rail 68 allows the maintenance part 38 to move to a position where the facing portion 32A, which is a portion of the maintenance part 38 facing the liquid ejection unit 22 during maintenance, does not overlap the body frame 20 in a viewing direction (top view) of the maintenance part 38 as viewed from the direction −Z opposite to the first direction D1. In particular, for example, the slide rail 68 allows the maintenance part 38 to move to a position where at least the facing portion 32A of the maintenance part 38 is located outside the upper member 20C, to which the scanning rails 29 are fixed, in the viewing direction (top view). For example, the slide rail 68 allows the maintenance part 38 to move to a position where at least the facing portion 32A does not overlap the liquid ejection unit 22 located at the discharge position EP in the viewing direction (top view). In other words, the slide rail 68 allows the maintenance part 38 to move to a position where at least the facing portion 32A of the maintenance part 38 does not overlap the housing 12 in the viewing direction (top view), for example. When the work position DP where the maintenance part 38 can be pulled out satisfies the above condition, the body frame 20 (upper members 20C), the housing 12, the scanning rails 29 of the liquid ejection unit 22, and the like are less likely to interfere with replacement work for the maintenance part 38 or replacement work for roll bodies R1 and R2.

An operator can move at least the facing portion 32A of the maintenance part 38 to a position not overlapping the body frame 20 in a top view (plan view) by sliding the slide stand 67 in the +Y direction. The position not overlapping the body frame 20 is a position where the facing portion 32A of the maintenance part 38 is disposed outside the body frame 20 in a top view. As illustrated in FIG. 5, at least the facing portion 32A of the maintenance part 38 pulled out to the work position DP is located outside the body frame 20 in a top view. That is, in the maintenance part 38, it is sufficient that at least the portion of the cloth 32 is disposed outside the body frame 20 in a top view. This is because the body frame 20 is less likely to interfere with replacement work for the cloth 32.

In the embodiment, the slide stand 67 on which the maintenance part 38 is placed is slidably guided in the Y direction by the slide rail 68. The slide rail 68 is fixed to the base stand 66, for example. Specifically, two slide rails 68 may be fixed to the stand 66A of the base stand 66, and one slide rail 68 may be fixed to the back plate 66B of the base stand 66. The number of the slide rails 68 may be one or two as long as the slide stand 67 can be slidably guided with respect to the base stand 66.

The slide stand 67 may include a stand 67A and a back plate 67B. The maintenance part 38 is placed on the stand 67A of the slide stand 67. The back plate 67B of the slide stand 67 may have a height equal to or greater than half the height of the maintenance part 38. By sliding the slide stand 67 in the second direction +D2 with respect to the base stand 66, the maintenance part 38 placed on the slide stand 67 can be pulled out to the work position DP. The operator performs the replacement work for the roll bodies R1 and R2 or the replacement work for the maintenance part 38, with respect to the maintenance part 38 pulled out to the work position DP. The work position DP is a replacement work position where the operator replaces the used cloth 32 with the new cloth 32 for the maintenance part 38.

The movement mechanism 50 includes a support 80 that moves in the first direction D1 by the power of the first drive unit 51. The support 80 may be attached to the slide stand 67. A pair of supports 80 may be capable of supporting the maintenance part 38 while sandwiching the maintenance part 38 from both sides in the Y direction. The pair of supports 80 may include a plate member fixed to the back plate 67B.

The maintenance part 38 includes the engaging portion 81 engageable with the positioning part 70. The maintenance part 38 may have the same number of engaging portions 81 as the number of positioning parts 70. The maintenance part 38 of the embodiment may have four engaging portions 81. The engaging portion 81 may pass through the pair of supports 80 and protrude outward therefrom.

The positioning part 70 may be fixed to the body frame 20 that supports the liquid ejection unit 22. The positioning part 70 may be fixed to the upper member 20C to which the scanning rails 29 are fixed. The plurality of positioning parts 70 are disposed at positions corresponding to the plurality of engaging portions 81. The plurality of (N) positioning parts 70 can position the maintenance part 38, which is moved in the first direction D1, by a plurality of parts (N parts) by engaging with the plurality of (N) engaging portions 81. The maintenance part 38 is positioned at the maintenance position MP illustrated in FIG. 4 by the positioning part 70.

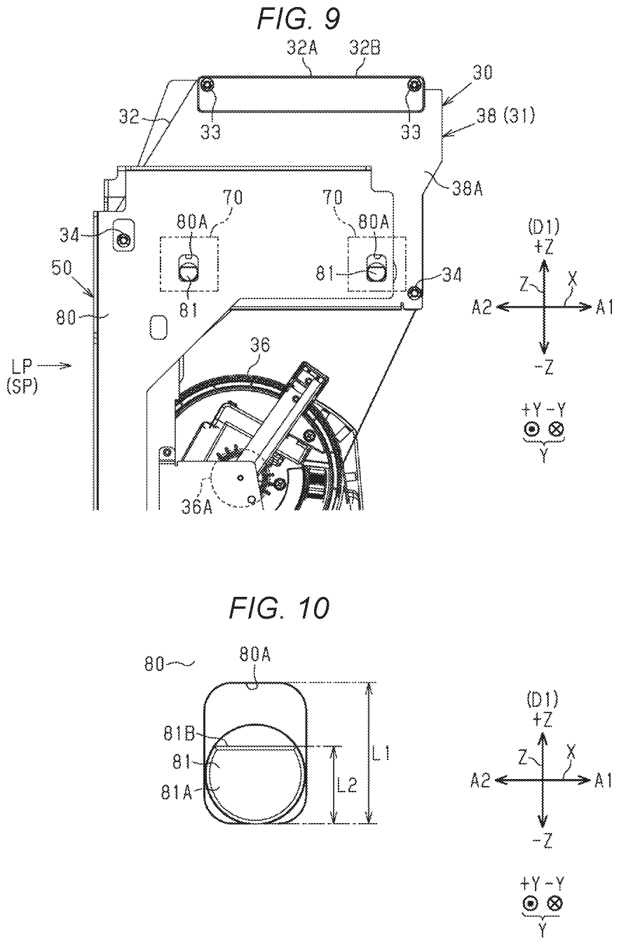

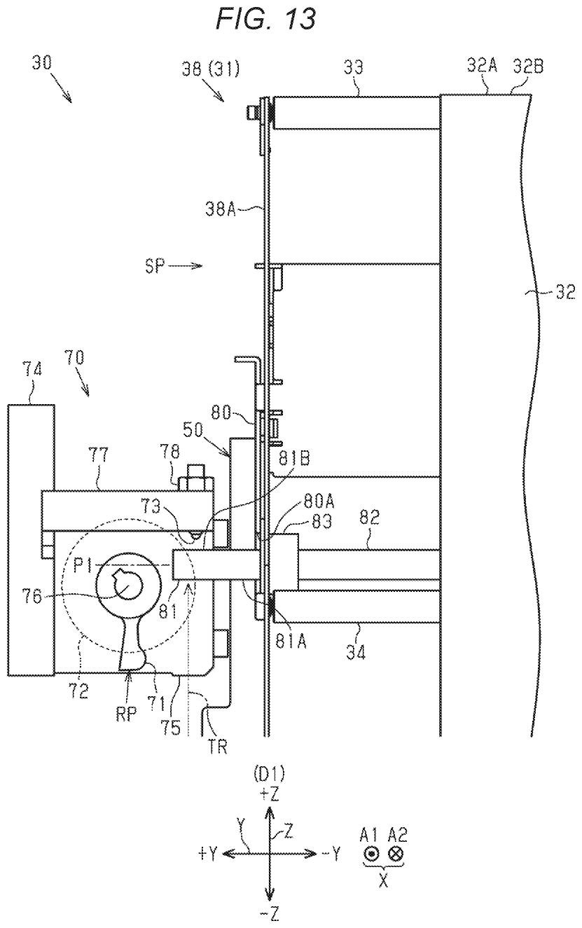

As illustrated in FIG. 5, the movement mechanism 50 includes a detection unit 69 fixed at a predetermined height of the assembly plate 54. A part to be detected (not illustrated) is fixed to a back surface of the back plate 66B of the base stand 66 at a position corresponding to the detection unit 69 in the Y direction. When the maintenance part 38 placed on the movable stand 37 is moved to a first movement position SP (see FIGS. 9 and 13) in the first direction D1 by the power of the first drive unit 51, the detection unit 69 detects the part to be detected. A height position of the part to be detected is set such that the detection unit 69 detects the part to be detected at the position where the shock absorbers 63 of the first restricting portion 62 abut the restricting plates 66C. When the control unit 100 receives a detection signal indicating that the part to be detected is detected by the detection unit 69, the control unit 100 stops the driving of the first drive unit 51. Therefore, the maintenance part 38 stops at the first movement position SP. The first movement position SP where the maintenance part 38 stops when the detection unit 69 detects the part to be detected is a position where the maintenance part 38 is transferred to the positioning part 70 for subsequent positioning. The positioning part 70 can perform the positioning operation on the maintenance part 38 that is moved to the first movement position SP.

### Configuration of Maintenance Part 38

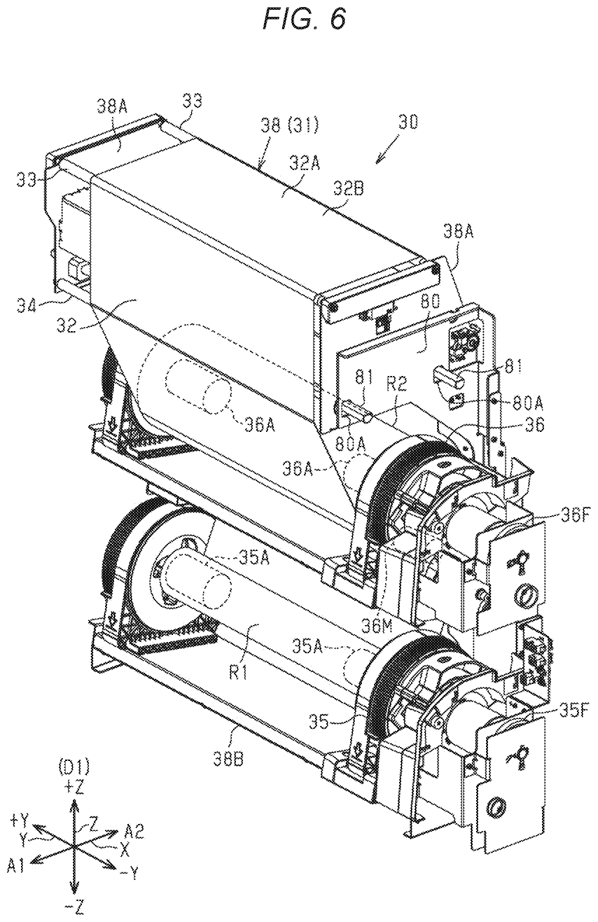

Next, a configuration of the maintenance part 38 will be described with reference to FIG. 6. FIG. 6 illustrates a state in which the pair of supports 80 are disposed at two side surfaces of the maintenance part 38. The maintenance part 38 is attached to the slide stand 67 via the pair of supports 80.

The maintenance part 38 includes the feeding part 35 set with the roll body R1 around which the unused cloth 32 is wound, and the winding part 36 that winds up the cloth 32 fed from the roll body R1. The maintenance part 38 includes a frame 38A. The feeding part 35 and the winding part 36 are assembled to the frame 38A. The feeding part 35 and the winding part 36 may be disposed one above the other. As illustrated in FIG. 6, the winding part 36 may be disposed above the feeding part 35. Conversely, the feeding part 35 may be disposed above the winding part 36. Since the feeding part 35 and the winding part 36 are disposed one above the other, the maintenance part 38 is integrated into a vertically long shape. The vertically long maintenance part 38 contributes to downsizing of the liquid ejection apparatus 11 in the scanning direction X.

As illustrated in FIG. 6, the maintenance part 38 includes a delivery roller 35A around which the cloth 32 is wound in a roll shape, and a winding roller 36A that winds up the cloth 32 from the delivery roller 35A. The maintenance part 38 includes a motor 36M as an example of a third drive unit that drives the winding roller 36A.

The delivery roller 35A is provided at the feeding part 35. The feeding part 35 may include a pair of delivery rollers 35A on both sides in an axial direction thereof. The roll body R1 of the cloth 32 is set at the feeding part 35. The roll body R1 includes a tube member (not illustrated) and the roll-shaped cloth 32 wound around an outer periphery of the tube member. The roll body R1 is set to the feeding part 35 by inserting the pair of delivery rollers 35A from both sides in the axial direction of the tube member.

The winding roller 36A is provided at the winding part 36. The winding part 36 may include a pair of winding rollers 36A on both sides in an axial direction thereof. The winding part 36 supports a tube member by inserting the pair of winding rollers 36A from both sides in the axial direction of the tube member. The winding roller 36A is driven and rotated by a driving force of the motor 36M. The roll body R2 supported by the pair of winding rollers 36A rotates in a winding direction by the driving force of the motor 36M. The winding part 36 winds up the used cloth 32 used in the maintenance as the roll body R2.

The cloth 32 fed from the roll body R1 of the feeding part 35 is wound up as the roll body R2 by the winding part 36 through the predetermined feed path. The cloth 32 is guided along the predetermined feed path by the pair of holding rollers 33 and the plurality of guide rollers 34 that are supported by the frame 38A.

The maintenance part 38 includes the facing portion 32A that is a portion of the cloth 32 facing the liquid ejection unit 22. The facing portion 32A is a portion where the cloth 32 is guided by the pair of holding rollers 33. The pair of holding rollers 33 are disposed at two different positions in the scanning direction X at the same height position. The liquid receiving surface 32B that is the surface of the facing portion 32A is a horizontal surface.

The liquid receiving surface 32B is used for the maintenance of the liquid ejection unit 22. The maintenance part 38 receives the liquid by the liquid receiving surface 32B. The liquid receiving surface 32B receives the liquid ejected from the nozzles 24 of the liquid ejection unit 22 when the flushing is performed as the maintenance of the liquid ejection unit 22. When the maintenance unit 30 is also used for the cleaning, the liquid receiving surface 32B receives the liquid discharged from the nozzles 24 of the liquid ejection unit 22 when the cleaning is performed as the maintenance. When an amount of liquid exceeding the threshold is received by the liquid receiving surface 32B, the cloth 32 is fed by the predetermined feed amount by driving the winding part 36. The liquid receiving surface 32B is changed to the surface of the unused cloth 32 by the feeding operation for the cloth 32. The winding part 36 winds up the cloth 32, which is used by receiving the liquid ejected or discharged from the liquid ejection unit 22, into a roll shape, thereby forming the roll body R2.

As illustrated in FIG. 6, the feeding part 35 includes a friction mechanism 35F at an end located outside a rotary portion including the roll body R1 set on the pair of feeding rollers 35A. The friction mechanism 35F generates rotational friction when the feeding part 35 rotates. The winding part 36 includes a friction mechanism 36F at an end located outside a rotary portion that rotates together with the roll body R2. The cloth 32 is fed from the roll body R1 set to the feeding part 35 by a winding force of the winding part 36. The winding part 36 winds up the cloth 32, which is fed from the roll body R1 by the winding force, as the roll body R2. At this time, a tension within a certain range is applied to the cloth 32 by the rotational friction generated by the friction mechanisms 35F and 36F. The cloth 32 is intermittently fed by a predetermined amount each time in a feeding direction in a state where a tension is applied by the winding force of the winding part 36 and the friction applied by the friction mechanisms 35F and 36F.

The maintenance part 38 includes the engaging portion 81 at a predetermined height. The engaging portion 81 is provided at a height position equal to or greater than half the entire length of the maintenance part 38 in the vertical direction Z. As an example, in the first direction D1, the engaging portion 81 is provided between the facing portion 32A and one of the delivery roller 35A and the winding roller 36A that is closer to the facing portion 32A. In the maintenance part 38 of the embodiment, the roller closer to the facing portion 32A in the first direction D1 among the delivery roller 35A and the winding roller 36A is the winding roller 36A. The engaging portion 81 is provided between the winding roller 36A and the facing portion 32A.

The engaging portion 81 is used to position the maintenance part 38 by engaging with the positioning part 70. By engaging with the engaging portion 81, the positioning part 70 positions the facing portion 32A (liquid receiving surface 32B) located at the upper end of the maintenance part 38 in the first direction D1. The engaging portion 81 is disposed at a position relatively close to the facing portion 32A, which is an object to be positioned of the maintenance part 38, in the first direction D1. Therefore, as compared with a configuration in which the engaging portion 81 is located far from the facing portion 32A in the first direction D1 that is the object to be positioned, high positioning accuracy of the facing portion 32A is easily obtained.

The maintenance part 38 includes a bottom 38B at a lower end thereof. When the maintenance part 38 is placed on the slide stand 67, the pair of supports 80 attached to the slide stand 67 are assembled to both side portions of the maintenance part 38 in the Y direction. Each support 80 has an opening 80A at a position corresponding to the engaging portion 81. The maintenance part 38 includes two engaging portions 81 extending in the Y direction on each of both sides in the Y direction. The engaging portion 81 passes through the opening 80A and extends outward in the Y direction. The engaging portion 81 and the opening 80A will be described in detail later.

### Operations of Movement Mechanism 50

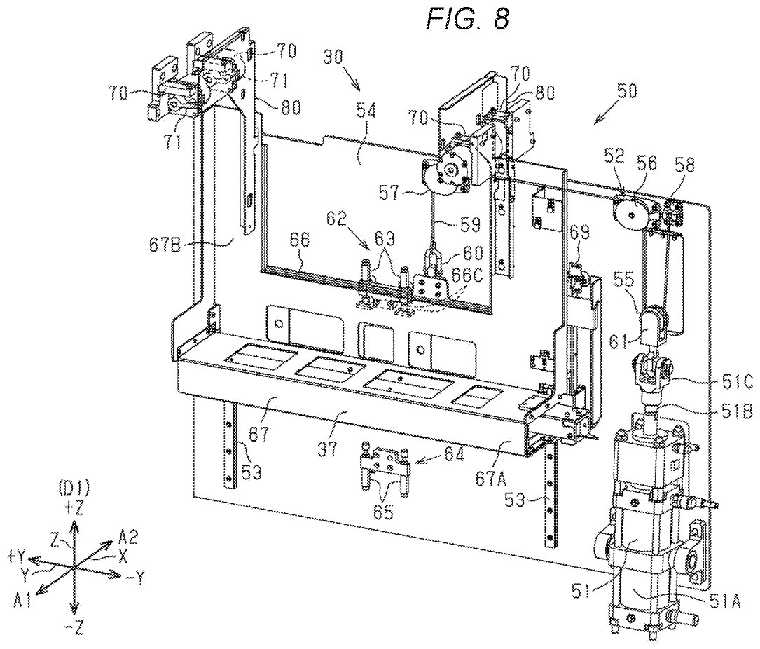

Next, operations of the movement mechanism 50 will be described with reference to FIGS. 7 and 8. FIG. 7 illustrates a state in which the movable stand 37 constituting the movement mechanism 50 is at the lowered position. FIG. 8 illustrates a state in which the movable stand 37 constituting the movement mechanism 50 is at a lifted position.

As illustrated in FIG. 7, the first drive unit 51 is in an extended state in which the piston rod 51B is extended. Since the pulley 55 coupled to the tip end of the piston rod 51B is at a lifted position, the portion of the wire rope 59 suspended from the pulley 57 is long, so that the movable stand 37 suspended from the wire rope 59 is lowered. The movable stand 37 is at the lowered position. The movable stand 37 is lowered along the two guide rails 53 arranged at different positions in the Y direction while maintaining a horizontal state. When the restricting plate 66C of the movable stand 37 abuts the shock absorber 65 of the second restricting portion 64, the movable stand 37 is positioned at the lowered position. The pair of supports 80 are attached to the back plate 67B of the slide stand 67 of the movable stand 37. The maintenance part 38 placed on the movable stand 37 is supported at both side surfaces by the pair of supports 80. At least one of the pair of supports 80 is detachably attached. When supporting the maintenance part 38 (see FIGS. 5 and 6) on the movable stand 37, at least one of the pair of supports 80 is detached, and then the maintenance part 38 is supported while being sandwiched in the Y direction by the pair of supports 80.

As illustrated in FIG. 8, the first drive unit 51 is in a contracted state in which the piston rod 51B is contracted. Since the pulley 55 coupled to the tip end of the piston rod 51B is at a lowered position, the portion of the wire rope 59 suspended from the pulley 57 is short, so that the movable stand 37 suspended from the wire rope 59 is lifted. The movable stand 37 is at the lifted position. The movable stand 37 is lifted along the two guide rails 53 while maintaining a horizontal state. When the restricting plate 66C of the movable stand 37 abuts the shock absorber 63 of the first restricting portion 62, the movable stand 37 is positioned at the lifted position. When the movable stand 37 reaches the lifted position, the detection unit 69 detects the part to be detected (not illustrated) that is provided at the movable stand 37. When the part to be detected is detected by the detection unit 69, the control unit 100 stops the driving of the first drive unit 51. The movable stand 37 stops at the lifted position in a state where the restricting plate 66C abuts the shock absorber 63. The maintenance part 38 (see FIGS. 5 and 6) placed on the movable stand 37 moves to the lifted position in the first direction D1 together with the movable stand 37. The pair of supports 80 supporting the maintenance part 38 at both side surfaces move to a height position corresponding to the positioning part 70 in the first direction D1.

As illustrated in FIGS. 7 and 8, three or more positioning parts 70 are provided. The three or more positioning parts 70 are arranged at arrangement positions such that projection positions thereof on a virtual plane orthogonal to the first direction D1 are at three or more different positions. In the embodiment, four positioning parts 70 are provided. The four positioning parts 70 are arranged at arrangement positions such that projection positions thereof on a virtual plane orthogonal to the first direction D1 are at four different positions.

The four positioning parts 70 are arranged at four positions that are different in at least one of the scanning direction X and the Y direction. The four positioning parts 70 are arranged at four positions on the front, rear, left, and right sides corresponding to a total of four engaging portions 81 (see FIG. 5) that pass through the pair of supports 80 sandwiching the maintenance part 38 at the lifted position in the Y direction, with two engaging portions 81 extending on each side.

### Regarding Configurations of Engaging Portion 81 of Maintenance Part 38 and Opening 80A of Support 80

Next, configurations of the maintenance part 38 and the support 80 will be described with reference to FIGS. 9 and 10. As illustrated in FIG. 9, the support 80 has the opening 80A through which the engaging portion 81 passes. The engaging portion 81 protrudes to the outside of the support 80 while being inserted into the opening 80A. The maintenance part 38 illustrated in FIG. 9 is at the lowered position that is a retracted position retracted in the first direction D1 from the maintenance position MP, or is in a process of moving in the first direction D1 from the lowered position by the movement mechanism 50. The engaging portion 81 engages with the support 80 that moves in the first direction D1. The support 80 moves in the first direction D1 together with the maintenance part 38 while supporting the maintenance part 38 via the engaging portion 81.

The engaging portion 81 is provided between the winding roller 36A and the facing portion 32A in the first direction D1. A pair of engaging portions 81 are fixed to the frame 38A. Specifically, the pair of engaging portions 81 extend outward from the frame 38A constituting both side portions of the maintenance part 38 in the Y direction. The maintenance part 38 is supported at a height of an upper portion of the side portion when the engaging portion 81 engages with the support 80. Therefore, the posture of the maintenance part 38 during the movement in the first direction D1 is easily stabilized.

When the movable stand 37 is moved in the first direction D1 by the movement mechanism 50 (see FIGS. 7 and 8), the maintenance part 38 placed on the movable stand 37 is moved by the same distance in the first direction D1 together with the movable stand 37. The support 80 that is a part of the movement mechanism 50 also moves in the first direction D1 together with the maintenance part 38. When the movement of the maintenance part 38 in the first direction D1 by the movement mechanism 50 is completed, the engaging portion 81 is disposed at a height position where the positioning part 70 indicated by a two-dot chain line in FIG. 9 can be engaged. That is, the engaging portion 81 is disposed at a height position where a lever 71 (see FIGS. 7 and 8) of the positioning part 70 can be engaged.

As illustrated in FIG. 10, in the first direction D1, a length L1 of the opening 80A is longer than a length L2 of the engaging portion 81. The engaging portion 81 is, for example, a shaft member 81A (see also FIG. 13). In the first direction D1, the length L1 of the opening 80A is larger than a thickness L2 of the shaft member 81A. The shaft member 81A may be, for example, a rod having a cross-sectional shape in which an upper portion of a circle is partially cut. The shaft member 81A has, at an upper portion, a restricted surface 81B formed of a flat surface orthogonal to the first direction D1. The shaft member 81A may be a polygonal rod such as a triangular prism or a quadrangular prism in which one surface serving as the restricted surface 81B is disposed in a direction orthogonal to the first direction D1.

The support 80 is attached to the maintenance part 38 in a state where the engaging portion 81 (shaft member 81A) is disposed at a position shifted in the direction −D1 (−Z direction) opposite to the first direction D1 in the opening 80A. That is, the engaging portion 81 is located to be shifted to a lower end side in the opening 80A. Since the lengths L1 and L2 satisfy L1>L2, the engaging portion 81 can be displaced relative to the opening 80A in the first direction D1. Therefore, after the movement of the maintenance part 38 in the first direction D1 together with the movable stand 37 by the movement mechanism 50 is completed, the engaging portion 81 can be displaced in the first direction D1 with respect to the support 80. The engaging portion 81 can be displaced in the first direction D1 within a range of (L1-L2) with respect to the support 80.

### Configuration of Positioning Part 70

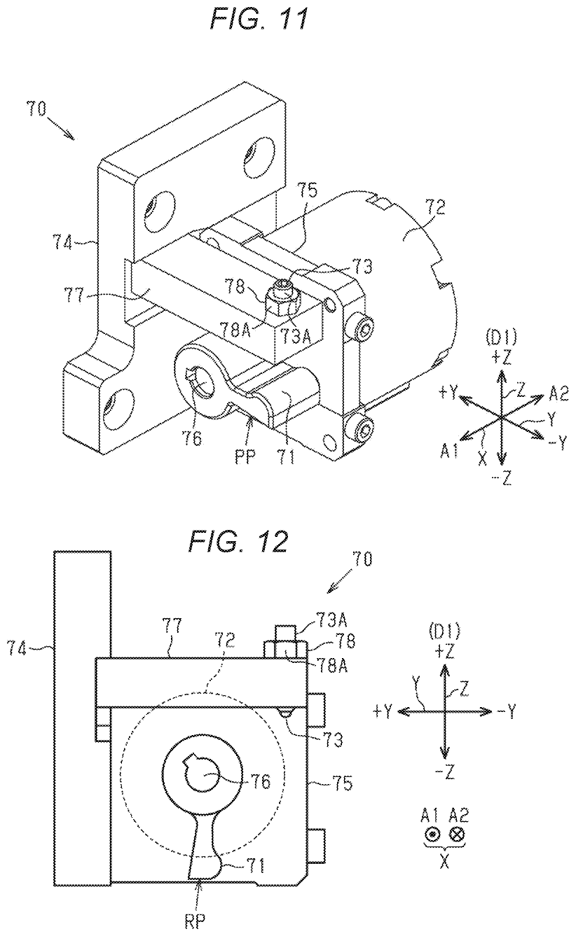

Next, a configuration of the positioning part 70 will be described with reference to FIGS. 11 and 12. The liquid ejection apparatus 11 includes the positioning part 70 illustrated in FIGS. 11 and 12 that positions the maintenance part 38.

FIG. 11 illustrates the lever 71 in a posture in a positioning state. FIG. 12 illustrates the lever 71 in a posture in a released state. The positioning part 70 positions the maintenance part 38 with respect to the liquid ejection unit 22 by moving the engaging portion 81 relative to the support 80 in the first direction D1. The positioning part 70 includes the lever 71 that is an example of a movable member.

The posture of the lever 71 can be changed between a released state RP illustrated in FIG. 12 and a positioning state PP illustrated in FIG. 11. The lever 71 is movable between the released state RP illustrated in FIG. 12 and the positioning state PP illustrated in FIG. 11 by pivoting about a pivot shaft 76. When the lever 71 is in the released state RP illustrated in FIG. 12, an extending direction of the lever 71 is directed in the −Z direction. When the lever 71 is in the positioning state PP illustrated in FIG. 11, the extending direction of the lever 71 is directed in the −Y direction. A moving direction of the engaging portion 81 is the first direction D1 (for example, the +Z direction). When the lever 71 is in the released state RP illustrated in FIG. 12, the extending direction of the lever 71 is directed along the first direction D1 that is the moving direction of the engaging portion 81. When the lever 71 is in the positioning state PP illustrated in FIG. 11, the extending direction of the lever 71 is directed in a direction intersecting the first direction D1 that is the moving direction of the engaging portion 81. When the lever 71 is in the released state RP illustrated in FIG. 12, the lever 71 is retracted from a movement path TR (see FIG. 13) of the engaging portion 81. When the lever 71 is in the positioning state PP illustrated in FIG. 11, the lever 71 enters the movement path TR of the engaging portion 81.

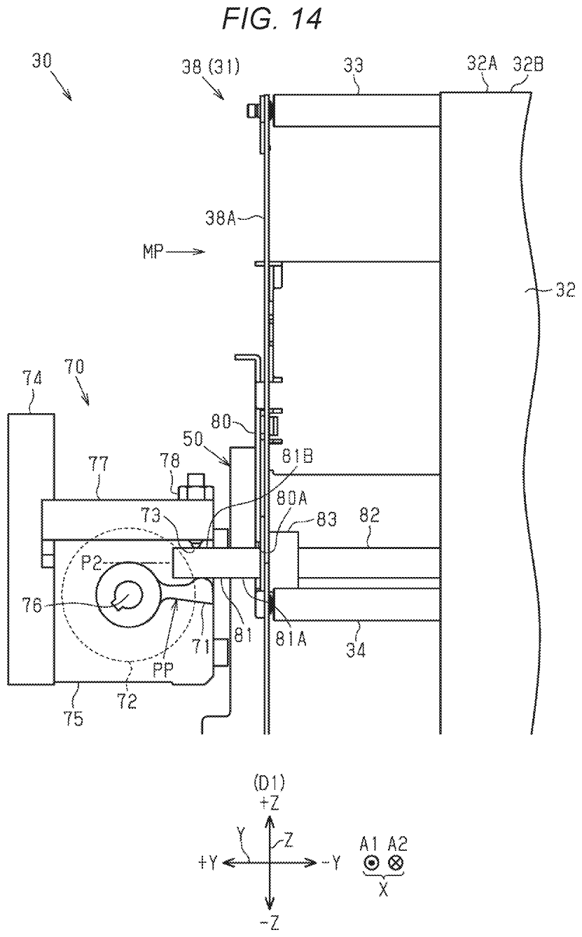

Specifically, the lever 71 is configured to be movable between the released state RP (see FIGS. 12 and 13) in which the lever 71 is not engaged with the engaging portion 81 and the positioning state PP (see FIGS. 11 and 14) in which the lever 71 is engaged with the engaging portion 81 to position the engaging portion 81 in the first direction D1. The lever 71 engages with the engaging portion 81 in a process of moving (pivoting) from the released state RP to the positioning state PP.

After the movement of the maintenance part 38 in the first direction D1 together with the movable stand 37 by the movement mechanism 50 is completed, the positioning part 70 positions the maintenance part 38 in the first direction D1 by pushing up the engaging portion 81 in the first direction D1 by the lever 71. A plurality of (for example, four) levers 71 push up the corresponding engaging portions 81 to individually set specified positions. Accordingly, the maintenance part 38 is positioned at the maintenance position MP in a posture in which the liquid receiving surface 32B is parallel to the nozzle surface 25.

Here, the position of the engaging portion 81 when the movement of the maintenance part 38 in the first direction D1 by the movement mechanism 50 is completed is a target position P1 (see FIG. 13) of the engaging portion 81 by the movement mechanism 50. The lever 71 can engage with the engaging portion 81 that is moved to the target position P1.

The positioning part 70 includes the second drive unit 72. When moving the engaging portion 81 in the first direction D1 from the target position P1 to be positioned, the second drive unit 72 moves the lever 71 from the released state RP to the positioning state PP. The second drive unit 72 is, for example, a motor. The lever 71 is coupled to an output shaft of the second drive unit 72. The lever 71 may be coupled to the output shaft of the second drive unit 72 via a gear mechanism. The second drive unit 72 may be a solenoid, a cylinder, or the like instead of the motor.

The pivot shaft 76 is fitted to, for example, the output shaft of the second drive unit 72. The lever 71 is fixed to the pivot shaft 76. The lever 71 is attached to the pivot shaft 76 in a state where the pivot shaft 76 is inserted into a circular hole formed in a base portion of the lever 71. The lever 71 is prevented from rotating with respect to the pivot shaft 76. The lever 71 is pivotable integrally with the pivot shaft 76.

As illustrated in FIGS. 11 and 12, the positioning part 70 may include a restricting portion 73. The restricting portion 73 restricts movement of the engaging portion 81 in the first direction D1. That is, the restricting portion 73 restricts further movement of the engaging portion 81 by abutting the engaging portion 81 that is pushed up in the first direction D1 by the lever 71.

The restricting portion 73 functions as a stopper for the engaging portion 81. The restricting portion 73 is disposed at a position corresponding to the movement path TR (see FIG. 13) of the engaging portion 81. The restricting portion 73 is disposed at a position where the restricting portion 73 can abut the engaging portion 81 that is displaced in the first direction D1 by the lever 71. A lower end of the restricting portion 73 functions as a stopper. The restricting portion 73 may include a spherical abutting portion at the lower end. The positioning part 70 may position the maintenance part 38 by bringing the engaging portion 81 to abut the restricting portion 73.

The positioning part 70 includes an attachment member 74 and an assembly member 75. The attachment member 74 is a plate-shaped member. The attachment member 74 is a member for attaching the positioning part 70 to the body frame 20 (see FIG. 5). The assembly member 75 is a plate-shaped member extending perpendicularly (for example, in the Y direction) from one surface of the attachment member 74. The second drive unit 72 is assembled to the assembly member 75. The positioning part 70 includes an extension member 77 extending in a direction (for example, the Y direction) perpendicular to the surface of the attachment member 74. The extension member 77 extends in a direction parallel to the extending direction of the assembly member 75. The extension member 77 is located directly above the lever 71. The restricting portion 73 is assembled to a tip end of the extension member 77.

The positioning part 70 may include an adjustment portion 78. The adjustment portion 78 is configured to adjust the position of the restricting portion 73 in the first direction D1. The adjustment portion 78 is assembled to the tip end of the extension member 77. The adjustment portion 78 may include a screw 73A provided for the restricting portion 73 and a nut member 78A screwed to the screw 73A. The nut member 78A may be fixed to the extension member 77, or may be fastened to the extension member 77 via screwing with the screw 73A of the restricting portion 73. The adjustment portion 78 can adjust the position of the restricting portion 73 in the first direction D1 by adjusting a screwing position of the screw 73A with respect to the nut member 78A located on an upper surface of the extension member 77.

The lever 71 pivots within a predetermined angle range about the pivot shaft 76 by a driving force of the second drive unit 72. The lever 71 is pivotable between the released state RP and the positioning state PP. In the process of pivoting in the direction from the released state RP toward the positioning state PP, the lever 71 can engage with the engaging portion 81 located at the target position P1 and displace the engaging portion 81 in the first direction D1 from the target position P1.

The predetermined angle range may be, for example, 30 degrees or more and 180 degrees or less. The predetermined angle range may be, for example, 50 degrees or more and 150 degrees or less. The predetermined angle range may be, for example, 60 degrees or more and 120 degrees or less. In the embodiment, the predetermined angle range is, for example, about 90 degrees. The predetermined angle range may be an angle range other than the above-described angle ranges. In short, it is sufficient that the predetermined angle range is a range in which the lever 71 can engage with the engaging portion 81 located at the target position P1 and can displace the engaging portion 81 in the first direction D1 by a movement amount necessary for positioning the maintenance part 38, in the process of moving from the released state RP, in which the lever 71 is not engaged with the engaging portion 81 moving toward the target position P1, to the positioning state PP.

An axis of the pivot shaft 76 of the lever 71 is parallel to the scanning direction X, for example. The lever 71 pivots about the axis parallel to the scanning direction X. The axial direction (X direction) of the pivot shaft 76 is orthogonal to the protruding direction (Y direction) of the engaging portion 81. Therefore, the lever 71 in the released state RP does not interfere with the movement path TR of the engaging portion 81 moving in the first direction D1. The lever 71 pivoting from the released state RP to the positioning state PP can engage with the engaging portion 81 that is located at the target position P1 after movement in the first direction D1 is completed.

### Positioning of Maintenance Part 38 by Movement Mechanism 50 and Positioning Part 70

Next, a configuration related to positioning of the maintenance part 38 by the movement mechanism 50 and the positioning part 70 will be described with reference to FIGS. 13 to 15.

The positioning part 70 can engage with the engaging portion 81 illustrated in FIG. 13 that is moved in the first direction D1 together with the support 80. As illustrated in FIG. 13, the engaging portions 81 are formed by two ends of a rod 82 passing through the maintenance part 38. The rod 82 is fixed to a pair of frames 38A by fixing members 83, and the engaging portions 81 at both ends thereof protrude outward in the Y direction from the pair of frames 38A.

The positioning part 70 includes the lever 71 as an example of a movable member engageable with the engaging portion 81 that is moved to the target position P1. When the engaging portion 81 is moved in the first direction D1 from the target position P1 to be positioned, the positioning part 70 moves the lever 71 from the released state RP to the positioning state PP by causing the second drive unit 72 to perform driving (FIGS. 13 and 14).

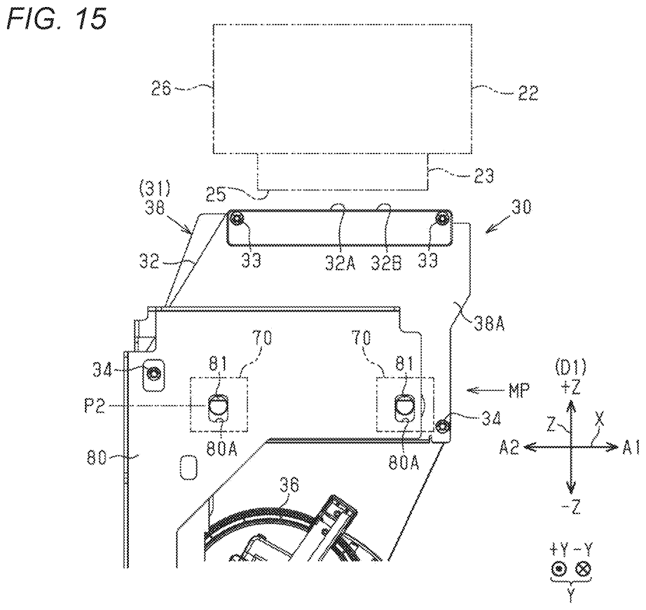

The positioning part 70 positions the maintenance part 38 with respect to the liquid ejection unit 22 (see FIGS. 2 and 4) by moving the engaging portion 81 relative to the support 80 in a direction parallel to the first direction D1. In the process of pivoting from the released state RP illustrated in FIG. 13 to the positioning state PP illustrated in FIG. 14, the lever 71 engages with the engaging portion 81 and pushes up the engaging portion 81 to a positioning position P2 (see FIGS. 14 and 15) in the first direction D1. In the embodiment, the relative movement of the engaging portion 81 with respect to the support 80 in the direction parallel to the first direction D1 (for example, the vertical direction Z) is the relative movement of the engaging portion 81 with respect to the support 80 in the first direction D1 (upward direction +Z). That is, the positioning part 70 positions the maintenance part 38 by displacing the engaging portion 81, which is located at the target position P1, upward relative to the support 80.

The control unit 100 performs the following control when moving and positioning the maintenance part 38, which is located at a lowered position LP (see FIG. 9) that is the retracted position, to the maintenance position MP. The control unit 100 causes the first drive unit 51 to perform driving in a state where the maintenance part 38 is located at the lowered position LP. After the start of the driving of the first drive unit 51, when the detection unit 69 detects that the support 80 is moved to a position where the engaging portion 81 is moved to the target position P1, the control unit 100 stops the driving of the first drive unit 51. Next, the control unit 100 causes the second drive unit 72 to perform driving to move the engaging portion 81 from the target position P1 to the positioning position P2 by the lever 71. Specifically, the posture of the lever 71 is changed from the released state RP to the positioning state PP, and the lever 71 engaged with the engaging portion 81 in the posture change process pushes up the engaging portion 81 to a position where the engaging portion 81 abuts the restricting portion 73. The engaging portion 81 is positioned at the positioning position P2 in the first direction D1 by abutting the restricting portion 73 (FIG. 14).

In the four positioning parts 70, heights of the restricting portions 73 are individually adjusted. The four restricting portions 73 are set such that the liquid receiving surface 32B, which is the surface of the facing portion 32A, is parallel to the nozzle surface 25 of the liquid ejection unit 22 at the discharge position EP when the corresponding engaging portions 81 abut the restricting portions 73.

As illustrated in FIG. 13, the engaging portion 81 inserted into the opening 80A of the support 80 moves in the first direction D1 together with the support 80 along the movement path TR. The engaging portion 81 moves from a lowered position when the maintenance part 38 is at the lowered position LP to the target position P1 illustrated in FIG. 13 along the movement path TR.

The lever 71 in the released state RP illustrated in FIG. 13 is retracted to the outside of the movement path TR of the engaging portion 81. The engaging portion 81 moves in the first direction D1 along the movement path TR without interfering with the lever 71. As illustrated in FIG. 13, the engaging portion 81 moves to the target position P1 without interfering with the lever 71.

As illustrated in FIG. 13, after the engaging portion 81 moves to the target position P1, the lever 71 pivots from the released state RP illustrated in FIG. 13 to the positioning state PP illustrated in FIG. 14. The lever 71 engages with the engaging portion 81 in the process of pivoting, and pushes up the engaging portion 81 to the positioning position P2 where the engaging portion 81 abuts the restricting portion 73 (FIG. 14). Further movement of the engaging portion 81 in the first direction D1 is restricted when the engaging portion 81 abuts the restricting portion 73. The engaging portion 81 is positioned at the positioning position P2 where the engaging portion 81 abuts the restricting portion 73.

In FIG. 14, one of the four positioning parts 70 is illustrated. The other three positioning parts 70 have the same configuration and perform the same positioning operation. At the four positioning parts 70, the four engaging portions 81 respectively abut the restricting portions 73 that are individually adjusted in height, and thus are respectively positioned at individually set height positions. The four engaging portions 81 are respectively positioned at the positioning positions P2 at the individually set heights. The height of the maintenance part 38 and the parallelism of the maintenance part 38 with the nozzle surface 25 are determined by the positioning positions P2 of the four engaging portions 81. The maintenance part 38 is positioned such that the liquid receiving surface 32B is maintained in parallel to the nozzle surface 25 and the liquid receiving surface 32B and the nozzle surface 25 are maintained at a specified distance. The specified distance is a distance (gap) within an appropriate range in which it is possible to restrict the adhesion of the liquid to the nozzle surface 25 caused due to the rebounding of the liquid on the liquid receiving surface 32B or the floating of the mist during the flushing or cleaning.

### Regarding Electrical Configuration of Maintenance Unit 30

Next, an electrical configuration related to positioning of the maintenance unit 30 will be described. As described above, the maintenance unit 30 includes the control unit 100 (see FIG. 1) and the detection unit 69 (see FIG. 5). The maintenance unit 30 includes the first drive unit 51 (see FIG. 5) that is a drive source of the movement mechanism 50 and the second drive unit 72 (see FIG. 11) that is a drive source of the positioning part 70. The detection unit 69 detects that the engaging portion 81 is moved in the first direction D1 to the target position P1 together with the support 80. When the engaging portion 81 is moved in the first direction D1 to the target position P1 together with the support 80 by the driving of the first drive unit 51, the detection unit 69 detects the part to be detected (not illustrated) provided at the movable stand 37. The control unit 100 receives a detection signal that is output when the detection unit 69 detects the part to be detected.

The control unit 100 controls the first drive unit 51 and the second drive unit 72. The positioning part 70 includes the lever 71 engageable with the engaging portion 81 that is moved to the target position P1. The second drive unit 72 can drive the lever 71 to move from the released state RP to the positioning state PP. Based on the detection signal from the detection unit 69, the control unit 100 detects that the engaging portion 81 is moved to the target position P1.

The control unit 100 performs the following (A) to (C) when positioning the maintenance part 38 with respect to the liquid ejection unit 22.
(A) The control unit 100 causes the first drive unit 51 to perform driving in a driving direction of moving the maintenance part 38 in the first direction D1.
(B) The control unit 100 stops the driving of the first drive unit 51 when the detection unit 69 detects that the engaging portion 81 is moved to the target position P1.
(C) The control unit 100 causes the second drive unit 72 to perform driving to move the engaging portion 81 from the target position P1 to the positioning position P2 by the lever 71.

Specifically, in the above (A), the first drive unit 51 is caused to perform driving in a state where the maintenance part 38 is at the lowered position LP retracted in the direction −D1 opposite to the first direction D1 with respect to the maintenance position MP. By the driving of the first drive unit 51, the movable stand 37 and the support 80 of the movement mechanism 50 are moved in the first direction D1 together with the maintenance part 38. In the above (B), the detection unit 69 detects that the engaging portion 81 is moved to the target position P1 by detecting the part to be detected that is provided at the movable stand 37. When the detection unit 69 detects that fact, the engaging portion 81 is stopped at the target position P1 by stopping the driving of the first drive unit 51. In the above (C), the lever 71 is moved in the direction from the released state RP toward the positioning state PP by the driving of the second drive unit 72. The lever 71 engages with the engaging portion 81 and moves the engaging portion 81 in the first direction D1 from the target position P1 to the positioning position P2 to position the engaging portion 81 at the positioning position P2.

Further, the control unit 100 may manage a usage amount of the cloth 32. Every time the operator replaces the cloth 32, the operator notifies the control unit 100 of information indicating completion of the replacement by a button operation from the operation panel. The control unit 100 performs the feeding operation for the cloth 32 by driving the motor 36M at a predetermined timing during a printing operation of the liquid ejection apparatus 11 or the like. The control unit 100 manages the liquid receiving amount of the liquid receiving surface 32B, and performs a feeding operation of feeding the cloth 32 by a predetermined amount by driving the motor 36M every time the liquid receiving amount exceeds a predetermined threshold. The control unit 100 causes a counter (not illustrated) to count a value corresponding to the feed amount of the cloth 32 every time the feeding operation for the cloth 32 is performed. When the count value of the counter reaches a value indicating a replacement timing, the control unit 100 prompts the operator to replace the cloth 32 by displaying the fact on a display unit of the operation panel. The operator who views the message or the like displayed on the display unit and prompting the replacement instructs, by a button operation on the operation panel, the control unit 100 to perform cloth replacement work.

When receiving the instruction for the cloth replacement work, the control unit 100 causes the first drive unit 51 and the second drive unit 72 to perform driving to move the maintenance part 38 from the maintenance position MP to the lowered position LP. The operator pulls out the lowered maintenance part 38 to the work position DP in the second direction +D2 (+Y direction) orthogonal to the first direction D1. After the replacement work for the cloth 32 with respect to the maintenance part 38 is completed, the operator pushes the maintenance part 38 to the lowered position LP. The operator instructs the control unit 100 to move the maintenance part 38 to the maintenance position MP by a button operation on the operation panel.

### Actions of Embodiment

Next, the movement and positioning of the maintenance part 38 at the lowered position LP to the maintenance position MP will be described. The maintenance part 38 is placed on the movable stand 37 constituting the movement mechanism 50 and is supported by a pair of supports 80. As illustrated in FIG. 9, the maintenance part 38 is supported in a state where the engaging portion 81 is located on the lower end side in the opening 80A with respect to the pair of supports 80. The engaging portion 81 is relatively movable in the first direction D1 in the opening 80A (FIG. 10).

The operator instructs the control unit 100 to move the maintenance part 38 to the maintenance position MP by a button operation or the like on the operation panel provided in the liquid ejection apparatus 11. When receiving an instruction by a button operation or the like from the operator, the control unit 100 causes the first drive unit 51 to perform driving. The first drive unit 51 formed of a cylinder performs driving from an extended state to a contracted state.

When the first drive unit 51 performs driving, the maintenance part 38 moves in the first direction D1 together with the movable stand 37. When the maintenance part 38 moves in the first direction D1 to the first movement position SP (see FIG. 13), the detection unit 69 detects the part to be detected. The control unit 100 stops the driving of the first drive unit 51 based on a detection signal from the detection unit 69. As a result, the maintenance part 38 stops after moving to the first movement position SP.

In the movement process in which the maintenance part 38 moves to the first movement position SP, the lever 71 of the positioning part 70 is in the released state RP directed downward (FIG. 13). The lever 71 is at a position retracted from the movement path TR of the engaging portion 81. The engaging portion 81 moves in the first direction D1 to the target position P1 along the movement path TR without interfering with the lever 71. When the maintenance part 38 stops at the first movement position SP, the engaging portion 81 is moved to the target position P1 illustrated in FIG. 13.

In the process of moving the maintenance part 38 to the first movement position SP, a force in the first direction D1 may be applied to the engaging portion 81, which is inserted into the opening 80A, from the pair of supports 80. Alternatively, the engaging portion 81 may move in the first direction D1 together with the maintenance part 38 without receiving a force in the first direction D1 from the support 80. When a force in the first direction D1 is applied from the pair of supports 80 to each engaging portion 81, since the maintenance part 38 is supported from the pair of supports 80 via the engaging portion 81 at the height position of the engaging portion 81, the posture of the maintenance part 38 when moving in the first direction D1 is stabilized.

After stopping the driving of the first drive unit 51, the control unit 100 then causes the second drive unit 72 to perform driving. When the second drive unit 72 performs driving, the lever 71 pivots from the released state RP (FIG. 13) to the positioning state PP (FIG. 14). As illustrated in FIG. 14, in the pivoting process, the lever 71 engages with the engaging portion 81 and pushes up the engaging portion 81 in the first direction D1 to a position where the engaging portion 81 abuts the restricting portion 73. As a result, the engaging portion 81 is positioned at the positioning position P2 abutting the restricting portion 73 (FIGS. 14 and 15). The positions of the restricting portions 73 of the N (for example, four) positioning parts 70 in the first direction D1 are individually adjusted by the adjustment portions 78, respectively. The restricting portions 73 are adjusted to positions such that the liquid receiving surface 32B, which is the surface of the facing portion 32A, and the nozzle surface 25 can maintain parallelism at a gap within a specified distance range.

Each of the engaging portions 81 pushed up by the N levers 71 is positioned at a position abutting the corresponding restricting portion 73. As a result, the maintenance part 38 is positioned at the maintenance position MP in a state where the liquid receiving surface 32B and the nozzle surface 25 maintain parallelism within a certain range at a gap within a specified distance range.

Therefore, it is possible to restrict the liquid, which is ejected from the nozzles 24 of the liquid ejection unit 22 during the cleaning and the flushing, from rebounding on the liquid receiving surface 32B and adhering to the nozzle surface 25, and to restrict a part of the liquid from floating as mist and adhering to the nozzle surface 25. In addition, since the parallelism between the nozzle surface 25 and the liquid receiving surface 32B is maintained within a certain range, it is possible to avoid an excessive difference in the gap between the nozzle surface 25 and the liquid receiving surface 32B across a plurality of nozzles 24. Therefore, the cleaning or the flushing is performed at an appropriate gap with respect to the liquid receiving surface 32B for all the nozzles 24.

The distance between the liquid receiving surface 32B and the nozzle surface 25 may be set to different values during the cleaning and during the flushing. In general, the discharge of the liquid from the nozzles 24 during the cleaning is more powerful than the ejection of the liquid from the nozzles 24 during the flushing. Therefore, in the discharge of the liquid, there is a tendency that the rebound of the liquid on the liquid receiving surface 32B is great and the mist is less likely to be generated. Therefore, during the cleaning, the first movement position SP of the maintenance part 38 may be set as the maintenance position MP by positioning the engaging portion 81 at the target position P1. In addition, the positioning position P2 where the positioning part 70 positions the engaging portion 81 may be set to two types for the cleaning and the flushing. For example, the lever 71 and the restricting portion 73 may be provided in two types for the cleaning and the flushing.

When the cloth 32 of the roll body R1 set to the feeding part 35 is consumed and runs out, the fact is displayed on the display unit. By a button operation on the operation panel, for example, the operator instructs the control unit 100 to perform the cloth replacement work. When the control unit 100 receives an instruction for the cloth replacement work from the operation panel, the control unit 100 controls the first drive unit 51 and the second drive unit 72 in operations reverse to those in the case of positioning. The control unit 100 first drives the second drive unit 72 to cause the lever 71 to pivot from the positioning state PP (FIG. 14) to the released state RP (FIG. 13).

Next, the control unit 100 causes the first drive unit 51 to perform driving from the contracted state to the extended state. Accordingly, the maintenance part 38 is lowered from the maintenance position MP to the lowered position LP together with the movable stand 37. At this time, the engaging portion 81 moves in the direction −D1 (−Z) opposite to the first direction D1 along the movement path TR illustrated in FIG. 13. A detection unit (not illustrated) may detect that the maintenance part 38 is lowered to the lowered position LP. When the maintenance part 38 is lowered to the lowered position LP, the control unit 100 stops the driving of the first drive unit 51. At the lowered position LP, the restricting plate 66C abuts the shock absorber 65 on the lower side, so that the shock at the time of stopping is alleviated.

Next, the operator grips a handle (not illustrated) and pulls out the maintenance part 38 in the second direction +D2 (+Y direction). As illustrated in FIG. 5, the maintenance part 38 is guided by the slide rail 68 together with the slide stand 67 with respect to the base stand 66 and is pulled out in the second direction +D2 (+Y direction). The operator can pull out the maintenance part 38 to the work position DP where the liquid receiving surface 32B does not overlap the body frame 20 in a top view. The operator replaces the roll bodies R1 and R2 or replaces the maintenance part 38 in a state where the maintenance part 38 is at the work position DP.

### Actions and Effects of Embodiment

According to the embodiment, the following actions and effects can be obtained.
(1) The maintenance unit 30 is used in the liquid ejection apparatus 11 including the liquid ejection unit 22. The maintenance unit 30 includes the maintenance part 38 that performs maintenance on the liquid ejection unit 22, the movement mechanism 50, and the positioning part 70. The movement mechanism 50 moves the maintenance part 38 in the first direction D1 toward the liquid ejection unit 22. The maintenance part 38 includes the engaging portion 81 engageable with the positioning part 70. The movement mechanism 50 includes the drive unit 51 and the support 80 that moves in the first direction D1 by power of the drive unit 51. The positioning part 70 engages with the engaging portion 81 that is moved in the first direction D1 together with the support 80. The positioning part 70 positions the maintenance part 38 with respect to the liquid ejection unit 22 by moving the engaging portion 81 relative to the support 80 in a direction parallel to the first direction D1. According to this configuration, the movement mechanism 50 moves the support 80 and the maintenance part 38 in the first direction D1, and the positioning part 70 engages with the engaging portion 81 to move the maintenance part 38 relative to the support 80 in the first direction D1, thereby positioning the maintenance part 38 with respect to the liquid ejection unit 22. Therefore, a movement amount of the maintenance part 38 can be secured, and the maintenance part 38 can be positioned with respect to the liquid ejection unit 22 with high accuracy. For example, the distance between the maintenance part 38 and the liquid ejection unit 22 in the first direction D1 can be specified with high accuracy.
(2) The positioning part 70 is fixed to the body frame 20 that supports the liquid ejection unit 22. According to this configuration, it is possible to specify the distance between the maintenance part 38 and the liquid ejection unit 22 with higher accuracy.
(3) The engaging portion 81 engages with the support 80 that moves in the first direction D1. According to this configuration, since the support 80 moving in the first direction D1 moves the maintenance part 38 in the first direction D1 via the engaging portion 81, the posture of the maintenance part 38 during the movement is easily stabilized.
(4) The positioning part 70 positions the maintenance part 38 with respect to the liquid ejection unit 22 by moving the engaging portion 81 relative to the support 80 in the first direction D1. According to this configuration, when the positioning part 70 moves the engaging portion 81 in the first direction D1, it is not necessary to move the support 80 of the movement mechanism 50 in the first direction D1.
(5) The engaging portion 81 is the shaft member 81A. The support 80 has the opening 80A through which the engaging portion 81 passes. In the first direction D1, the length L1 of the opening 80A is larger than the thickness L2 of the shaft member 81A. According to this configuration, when the positioning part 70 moves the engaging portion 81 in the first direction D1, it is not necessary to move the support 80 of the movement mechanism 50 in the first direction D1.
(6) The positioning part 70 includes the lever 71 as an example of a movable member movable between the released state RP in which the lever 71 is not engaged with the engaging portion 81 and the positioning state PP in which the lever 71 is engaged with the engaging portion 81 to position the engaging portion 81 in the first direction D1. The lever 71 engages with the engaging portion 81. According to this configuration, the arrangement of the lever 71 at a position where the lever 71 does not interfere with the movement path TR of the engaging portion 81 and the movement of the lever 71 engaged with the engaging portion 81 can be implemented.
(7) An example of the movable member is the lever 71 that changes the posture between the released state RP and the positioning state PP. According to this configuration, when the lever 71 as an example of the movable member is in the released state RP, the lever 71 does not interfere with the movement path of the engaging portion 81 that moves in the first direction D1. When the lever 71 is in the positioning state PP, it is possible to specify the distance between the liquid ejection unit 22 and the maintenance part 38 by engaging with the engaging portion 81. Since the movable member is the lever 71, the released state RP and the positioning state PP can be easily implemented with a relatively simple configuration and a small arrangement space.
(8) Three or more positioning parts 70 are provided. The three or more positioning parts 70 are arranged at arrangement positions such that projection positions thereof on a virtual plane orthogonal to the first direction D1 are at three or more different positions. According to this configuration, since the maintenance part 38 is supported at three or more different positions on a virtual plane, the facing portion 32A of the maintenance part 38 can be positioned to be parallel to the virtual plane. Therefore, the parallelism between the nozzle surface 25 of the liquid ejection unit 22 and the facing portion 32A of the maintenance part 38 is easily secured. In particular, in the embodiment, four positioning parts 70 are provided. The four positioning parts 70 are arranged at arrangement positions such that projection positions thereof on a virtual plane orthogonal to the first direction D1 are at four different positions. Therefore, the maintenance part 38 is stably supported on the front, rear, left, and right sides.
(9) The positioning part 70 includes the restricting portion 73 that restricts the movement of the engaging portion 81 in the first direction D1, and the adjustment portion 78 that can adjust the position of the restricting portion 73 in the first direction D1.

According to this configuration, an upper limit position of the engaging portion 81 can be restricted by the stopper, and the upper limit position can be adjusted.
(10) The maintenance unit 30 includes the control unit 100 and the detection unit 69 that detects that the engaging portion 81 is moved in the first direction D1 to the target position P1 together with the support 80. The drive unit 51 is referred to as the first drive unit 51. The positioning part 70 includes the lever 71 as an example of the movable member engageable with the engaging portion 81 that is moved to the target position P1, and the second drive unit 72 that moves the lever 71 from the released state RP to the positioning state PP when the engaging portion 81 is moved in the first direction D1 from the target position P1 to be positioned. The control unit 100 causes the first drive unit 51 to perform driving from a state where the maintenance part 38 is at the retracted position. After the start of the driving of the first drive unit 51, when the detection unit 69 detects that the support 80 is moved to a position where the engaging portion 81 is moved to the target position P1, the control unit 100 stops the driving of the first drive unit 51 and causes the second drive unit 72 to perform driving to move the engaging portion 81 from the target position P1 to the positioning position P2 by the lever 71 as an example of the movable member. According to this configuration, the movement of the support 80 by the driving of the first drive unit 51 and the movement of the engaging portion 81 by the driving of the second drive unit 72 are linked, and thus it is possible to quickly position the maintenance part 38 at a specified position with respect to the liquid ejection unit 22.
(11) The movement mechanism 50 includes the slide rail 68 that allows the maintenance part 38 to move in the second direction +D2 orthogonal to the first direction D1. The slide rail 68 allows the maintenance part 38 to move to a position where at least the facing portion 32A, which is a portion of the maintenance part 38 facing the liquid ejection unit 22 during maintenance, does not overlap the body frame 20 in a viewing direction of the maintenance part 38 as viewed from a direction opposite to the first direction D1. According to this configuration, the replacement work for the maintenance part 38 or the work of replacing a used consumable in the maintenance part 38 with an unused consumable is facilitated. In the latter case, for example, the replacement work for the roll bodies R1 and R2 is facilitated.
(12) The maintenance part 38 includes the delivery roller 35A around which the cloth 32 is wound in a roll shape, the winding roller 36A that winds up the cloth 32 from the delivery roller 35A, and the motor 36M as an example of a third drive unit that drives the winding roller 36A. According to this configuration, the maintenance of the liquid ejection unit 22 can be performed with the cloth 32, and good maintenance can be continued by changing the portion of the cloth 32 stained in the maintenance to the unused portion of the cloth 32.
(13) The maintenance part 38 includes the facing portion 32A that is a portion of the cloth 32 facing the liquid ejection unit 22. In the first direction D1, the engaging portion 81 is provided between the facing portion 32A and one of the delivery roller 35A and the winding roller 36A that is closer to the facing portion 32A. According to this configuration, since the engaging portion 81 is positioned at a position close to the facing portion 32A, the liquid ejection unit 22 and the facing portion 32A are easily kept parallel to each other.
(14) The liquid ejection apparatus 11 includes the maintenance unit 30 and the liquid ejection unit 22. According to this configuration, in the liquid ejection apparatus 11, the movement amount of the maintenance part 38 in the maintenance unit 30 can be secured, and the distance between the maintenance part 38 and the liquid ejection unit 22 can be specified with high accuracy.
(15) The liquid ejection apparatus 11 includes the maintenance unit 30 and the liquid ejection unit 22. In a state where the maintenance part 38 is positioned with respect to the liquid ejection unit 22, the maintenance part 38 performs the maintenance in which the liquid ejected by the liquid ejection unit 22 is received by the cloth 32. According to this configuration, in the liquid ejection apparatus 11, the movement amount of the maintenance part 38 in the maintenance unit 30 can be secured, and the distance between the maintenance part 38 and the liquid ejection unit 22 can be specified with high accuracy. It is possible to appropriately perform the maintenance in which the liquid ejected by the liquid ejection unit 22 is received by the cloth 32.
(16) The maintenance unit 30 is used in the liquid ejection apparatus 11 including the liquid ejection unit 22 having the nozzle surface 25. The maintenance unit 30 includes the maintenance part 38, the movement mechanism 50, and the engaging portion 81. The maintenance part 38 includes the delivery roller 35A around which the cloth 32 is wound in a roll shape, the winding roller 36A that winds up the cloth 32 from the delivery roller 35A, and the motor 36M as an example of a drive unit that drives the winding roller 36A. Furthermore, the maintenance part 38 includes the facing portion 32A that causes the liquid receiving surface 32B, which is an example of a maintenance surface of the cloth 32, to face the nozzle surface 25 of the liquid ejection unit 22. The movement mechanism 50 moves the liquid receiving surface 32B in the first direction D1 toward the nozzle surface 25 of the liquid ejection unit 22. The engaging portion 81 is provided to be movable integrally with the facing portion 32A and engages with the movement mechanism 50. In the first direction D1, the engaging portion 81 is provided between the facing portion 32A and one of the delivery roller 35A and the winding roller 36A that is closer to the facing portion 32A. According to this configuration, since the engaging portion 81 is provided at a position close to the facing portion 32A, the nozzle surface 25 and the liquid receiving surface 32B are easily kept parallel to each other.

### Modifications

The embodiment described above may be modified as the following modifications. The embodiment described above and the following modifications can be implemented in combination within a range where no technical contradictions occur. In addition, the following modifications can be appropriately combined and implemented.

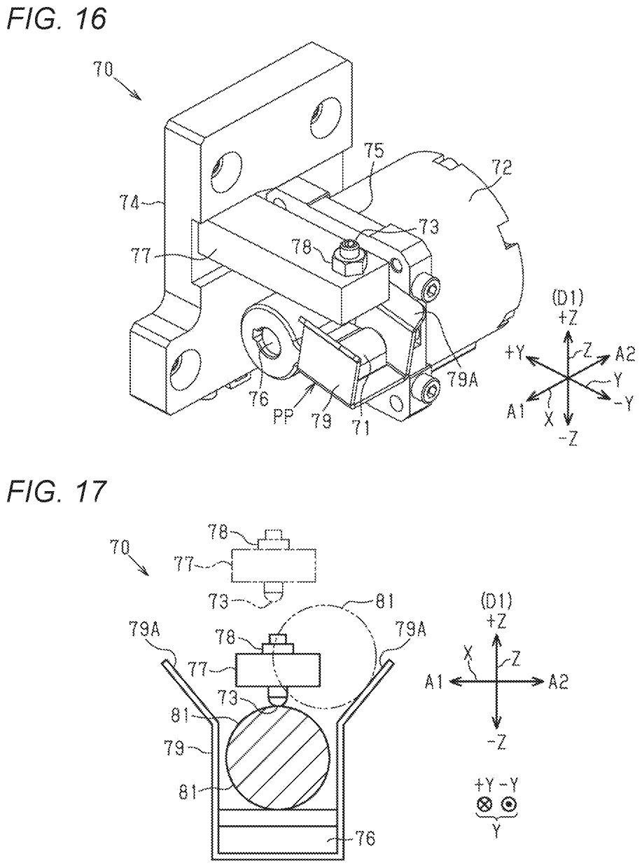

As illustrated in FIGS. 16 and 17, a guide member 79 may be provided for the lever 71 that is an example of a movable member. The guide member 79 has an inclined surface 79A capable of guiding the engaging portion 81 in a direction orthogonal to the first direction D1. In the example illustrated in FIGS. 16 and 17, the guide member 79 can guide the engaging portion 81 in the scanning direction X by the inclined surface 79A. The released state RP and the positioning state PP of the lever 71 are the same as those in the above-described embodiment. The posture of the lever 71 and the guide member 79 is changed from the released state RP (the same angular position as in FIGS. 12 and 13) to the positioning state PP. In this process, the lever 71 pushes up the engaging portion 81, which is guided by the guide member 79, to a position where the engaging portion 81 abuts the restricting portion 73. In FIG. 17, this state of positioning is illustrated by relative positions of the restricting portion 73 and the engaging portion 81 with respect to the lever 71 and the guide member 79. The restricting portion 73 and the engaging portion 81 before positioning are located at positions indicated by two-dot chain lines. The lever 71 and the guide member 79 guide the engaging portion 81 indicated by the two-dot chain line along the inclined surface 79A to an appropriate position in the scanning direction X in the process of changing the posture from the released state RP to the positioning state PP. Thereafter, the lever 71 pushes up the engaging portion 81 to a position where the engaging portion 81 abuts the restricting portion 73. Therefore, the engaging portion 81 abuts the restricting portion 73 at a position where a shift in the scanning direction X is reduced to be small. Therefore, the maintenance part 38 can be positioned at an assumed height position with high accuracy while maintaining the parallelism between the facing portion 32A and the nozzle surface 25. As described above, the lever 71 and the guide member 79 can position the engaging portion 81 in the first direction D1 and a direction (for example, the scanning direction X) orthogonal to the first direction D1. Therefore, the parallelism between the nozzle surface 25 of the liquid ejection unit 22 and the facing portion 32A of the maintenance part 38 is easily secured. The direction in which the guide member 79 guides the engaging portion 81 is not limited to the scanning direction X and may be the Y direction as long as the direction intersects the first direction D1.

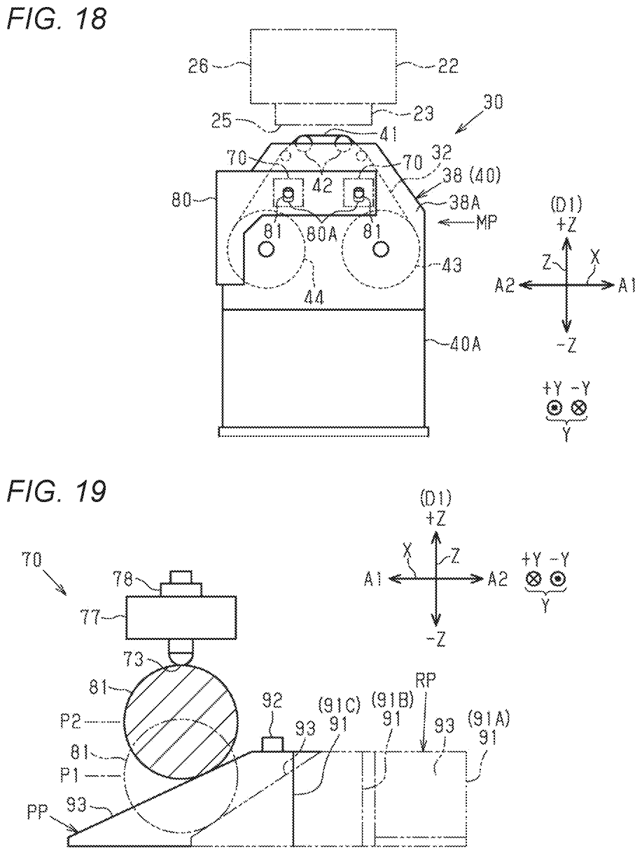

The maintenance unit 30 is not limited to the configuration in which the liquid receiving portion 31 is the maintenance part 38. The maintenance unit 30 may have a configuration in which the wiping part 40 illustrated in FIG. 18 is the maintenance part 38. In other words, the maintenance unit 30 is not limited to a cleaning unit in which the liquid receiving portion 31 is the maintenance part 38, and may be a wiping unit in which the wiping part 40 is the maintenance part 38. The maintenance unit 30 that is a wiping unit includes the wiping part 40 illustrated in FIG. 18, and the movement mechanism 50 and the positioning part 70 that are basically the same as those in the embodiment described above. As illustrated in FIG. 18, the wiping part 40 includes the wiping portion 41 as an example of a facing portion configured to face the nozzle surface 25. The wiping part 40 performs maintenance of wiping the nozzle surface 25 of the liquid ejection unit 22 with the wiping portion 41. A wiping surface as a surface by which the wiping portion 41 wipes the nozzle surface 25 corresponds to an example of a maintenance surface.

The wiping part 40 includes the frame 38A, the feeding part 43, the winding part 44, the pressing roller 42, and the like. The cloth 32 is pushed up in the first direction D1 by the pressing roller 42 at a portion in the middle of the path from the feeding part 43 to the winding part 44, and thus the protruding wiping portion 41 is formed. The wiping part 40 may include a lifting and lowering portion 40A. The lifting and lowering portion 40A lifts and lowers the wiping portion 41. Accordingly, the wiping portion 41 may be configured to come into contact with the nozzle surface 25 of the liquid ejection unit 22. Alternatively, the nozzle surface 25 and the wiping portion 41 may be brought into contact with each other by lowering the liquid ejection unit 22. The wiping portion 41 may wipe the nozzle surface 25 by moving the liquid ejection unit 22 in the scanning direction X, or the wiping portion 41 may wipe the nozzle surface 25 by moving the wiping portion 41 in the scanning direction X.

As illustrated in FIG. 18, both side portions of the maintenance part 38 (wiping part 40) in the Y direction are supported by a pair of supports 80. The support 80 has basically the same configuration as that of the above-described embodiment. The support 80 has the opening 80A at a position corresponding to the engaging portion 81. A plurality of engaging portions 81 protruding from the side portion of the maintenance part 38 are inserted into the opening 80A. In the first direction D1, the engaging portion 81 is provided between the wiping portion 41 and one of a delivery roller of the feeding part 43 and a winding roller of the winding part 44 that is closer to the wiping portion 41. The levers 71 of N (for example, four) positioning parts 70 push up the engaging portions 81 to positions where the engaging portions 81 abut the restricting portions 73, whereby the wiping part 40 moved to the target position P1 in the first direction D1 by driving of the first drive unit 51 is positioned at a plurality of parts individually by N positioning parts 70. Therefore, the wiping part 40 can be positioned in a state where the wiping portion 41 comes into contact with the nozzle surface 25 at a wiping pressure within a certain range and the parallelism within a certain range is maintained therebetween.

A pivot direction of the lever 71, which is an example of a movable member, is not limited to a pivot direction with an axial direction of the pivot shaft 76 being a direction intersecting the first direction D1. As illustrated in FIG. 19, a pivot direction of a lever 91, which is an example of the movable member, may be a pivot direction with an axial direction of a pivot shaft 92 being a direction parallel to the first direction D1. In FIG. 19, the lever 91 (91A) in the released state RP is indicated by a two-dot chain line, and the lever 91 (91C) in the positioning state PP is indicated by a solid line. In addition, the lever 91 (91B) taking a posture at an angle between the released state RP and the positioning state PP is indicated by a two-dot chain line. The lever 91 has, at its tip end, a guide surface 93 formed of an inclined surface whose height gradually decreases in the pivot direction in which the lever 91 moves from the released state RP to the positioning state PP. As illustrated in FIG. 19, in the process of the lever 91 pivoting from the released state RP toward the positioning state PP, the guide surface 93 engages with the engaging portion 81 indicated by a two-dot chain line, and pushes up the engaging portion 81 from the position indicated by the two-dot chain line to the positioning position indicated by a solid line abutting the restricting portion 73. As described above, the pivot direction of the lever 91 may be set to any direction as long as the engaging portion 81 can be displaced in the first direction D1.

The wiping part 40 illustrated in FIG. 18 is not limited to a cloth wiper that wipes the nozzle surface 25 with the wiping portion 41 formed of the cloth 32, and may be configured to wipe the nozzle surface 25 with a wiper blade. In this case, at the work position DP, instead of replacing the cloth 32 or the wiping part 40, adjustment, repair, or replacement of the wiper blade may be performed as predetermined work.

In the embodiment and the modifications, it is sufficient that at least three positioning parts 70 are provided in order to secure the parallelism between the nozzle surface 25 and the facing portion 32A. The number of positioning parts 70 is not limited to four, and may be three or five or more. In any case, it is sufficient that at least three projection positions obtained by projecting at least three positioning parts 70 in the first direction D1 on a virtual plane orthogonal to the first direction D1 are three or more different positions. For example, a polygon having a projection point, which is a projection position of an engaged portion (engagement point) between the positioning part 70 and the engaging portion 81, as a vertex may be a polygon having three or more corners. The polygon may be a triangle or a pentagon. Also in these configurations, the facing portion 32A of the maintenance part 38 can be positioned in the first direction D1 with high accuracy while maintaining high parallelism with respect to the nozzle surface 25.

The number of positioning parts may be two. For example, the number of levers as an example of the movable member may be two. Even if the number of positioning parts 70 or levers 71 is two, the maintenance part 38 can be positioned. Further, the number of positioning parts 70 is not limited to two or more, and may be one. For example, the number of levers 71 as an example of the movable member may be one.

The engaging portion 81 may be disposed at a position other than the position between the facing portion 32A and the winding roller 36A in the first direction D1. For example, the engaging portion 81 may be disposed at the same position as the winding roller 36A in the first direction D1, at a position between the delivery roller 35A and the winding roller 36A, or at the same position as the delivery roller 35A. The engaging portion 81 may be disposed at a position of half or more or ⅔ or more of the entire length of the maintenance part 38 in the first direction D1 toward the facing portion 32A. The engaging portion 81 may be disposed at the same position as the facing portion 32A in the first direction D1 or at a position in the first direction D1 of the facing portion 32A as long as the engaging portion 81 does not interfere with a scanning path of the liquid ejection unit 22.

The movable member of the positioning part 70 is not limited to the lever 71. The movable member may be linearly movable in two directions. For example, the movable member may be movable in a first linear direction parallel to the XY plane by power of a first linear drive unit and in a second linear direction parallel to the Z direction by power of a second linear drive unit. Also with this configuration, it is possible to perform the retraction of the movable member to the released state RP where the movable member is not engaged with the engaging portion 81, and to perform a positioning operation (for example, push-up operation) of the movable member that further moves the engaging portion 81, which is moved to the target position P1, to the positioning position P2. In this case, the first linear drive unit and the second linear drive unit correspond to the second drive unit.

The pivot direction of the lever of the positioning part 70 is not limited to the pivot direction with the axial direction of the pivot shaft 76 being the X direction. The pivot direction may be a pivot direction with the axial direction of the pivot shaft 76 being the Y direction. As described above, it is sufficient that the axial direction of the pivot shaft 76 is a direction intersecting the first direction D1, such as the X direction or the Y direction. In addition, when the maintenance unit 30 includes a plurality of positioning parts 70, the plurality of levers 71 may be different in the axial direction of the pivot shaft 76.

The engaging portion 81 is not limited to the shaft member 81A. The engaging portion 81 may be an engaging recess, a hole, or a notch. For example, the positioning part 70 may include a shaft member as the movable member, and the shaft member may be engaged with the engaging portion 81 by being inserted into a recess of the engaging portion 81 formed of an engaging recess or the like. In this case, the movable member is displaced in the first direction D1 after being inserted into the engaging portion 81 formed of an engaging recess or the like, thereby moving the engaging portion 81 in the first direction D1 to the positioning position P2.

The first direction D1 is not limited to the +Z direction that is the upward direction. The first direction D1 may be a direction intersecting the +Z direction at an acute angle. The first direction D1 may be the −Z direction or a direction intersecting the −Z direction at an acute angle. Further, the first direction D1 may be a direction having no Z-direction component. For example, the first direction D1 may be the X direction or the Y direction, or may be a direction intersecting the X direction or the Y direction at an acute angle on the XY plane. As described above, the first direction D1, which is a direction in which the maintenance part 38 is moved by the movement mechanism 50 when the maintenance part 38 is positioned with respect to the liquid ejection unit 22, may be any direction.

In the above-described embodiment, the support 80 may not have the opening 80A. The opening 80A may be replaced with a recess or a notch. The opening 80A, the recess, and the notch allow the engaging portion 81 to move relative to the support 80 of the engaging portion 81 in the first direction D1 while guiding the engaging portion 81.

Although a configuration is adopted in the above-described embodiment in which the engaging portion 81 engages with the support 80 of the movement mechanism 50, the configuration may include an engaging portion that engages with the support 80 of the movement mechanism 50 and the engaging portion 81 that does not engage with the support 80 of the movement mechanism 50. In this case, the positioning part 70 may be configured to engage with the engaging portion 81 that does not engage with the support 80. That is, the maintenance part 38 may separately include an engaging portion that engages with the support 80 when moving in the first direction D1 and the engaging portion 81 that engages with the positioning part 70 when positioning the maintenance part 38 moved in the first direction D1.

The support 80 may not be disposed at a position corresponding to the engaging portion 81, and the engaging portion 81 may not be guided by the support 80. For example, the support 80 may support a side portion of the maintenance part 38 at a position lower than the engaging portion 81.

The support 80 that supports the side portion of the maintenance part 38 may be omitted. In this case, the movable stand 37 that supports the maintenance part 38 moving in the first direction D1 corresponds to an example of a support. As described above, the support is not limited to a configuration of supporting the side portion of the maintenance part 38, and is sufficient to be a component of the movement mechanism 50 that moves in the first direction D1 together with the maintenance part 38.

In the above-described embodiment, the support 80 may be a guide portion movable in the first direction D1 together with the maintenance part 38 relative to the movable stand 37. The guide portion is configured such that the support 80 is movable in the first direction D1 relative to the movable stand 37 via a rail. The guide portion moves together with the maintenance part 38 relative to the movable stand 37 while supporting the side portion of the maintenance part 38. When the positioning part 70 moves the engaging portion 81 in the first direction D1, the guide portion moves to the positioning position P2 by moving in the first direction D1 together with the maintenance part 38 relative to the movable stand 37. In this case, the movable stand 37 corresponds to an example of the support. In this configuration, since the guide portion can be fixed to the side portion of the maintenance part 38, the maintenance part 38 can be moved in the first direction D1 in a stable posture.

The position and number of the engaging portions 81 may be changed as appropriate. For example, the position of the engaging portion 81 is not limited to positions of both side portions in a longitudinal direction in a top view of the maintenance part 38, and may be positions of both side portions in a lateral direction or positions of two or more different side portions selected from both side portions in the longitudinal direction and both side portions in the lateral direction. The position and number of the positioning parts 70 may be appropriately changed according to the positions of the engaging portions 81.

The slide rail 68 may be omitted. For example, a lowered position to which the maintenance part 38 is lowered from the maintenance position MP may be the work position DP. For example, when the maintenance unit 30 is located at an end in the housing 12, the maintenance part 38 at the lowered position can be replaced by opening a door at an end side portion of the housing 12. In addition, in a case where the first direction D1 is a direction intersecting the vertical direction Z, if a part of the maintenance part 38 is exposed to the outside of the housing 12 when the maintenance part 38 is moved in a direction opposite to the first direction D1 from the maintenance position MP, the position may be set as the work position DP.

The positioning part 70 is not limited to a configuration fixed to the body frame 20 that supports the liquid ejection unit 22. The positioning part 70 may be fixed to a frame different from the body frame 20. In short, it is sufficient that the positioning part 70 is fixed to a frame or a member capable of positioning the maintenance part 38 with respect to the liquid ejection unit 22. The plurality of positioning parts 70 may be fixed to different frames or different members.

Although the engaging portion 81 is pushed up by the lever 71 constituting the positioning part 70 in the above-described embodiment, the positioning part 70 may pull up the engaging portion 81 by a movable member. For example, the positioning part 70 may include an arm as an example of a movable member at a position above the engaging portion 81 located at the target position P1, and the arm may hook and pull up the engaging portion 81.

The positioning part 70 may not include a movable member such as the lever 71. For example, the positioning part 70 may have a configuration including a biasing member that biases the engaging portion 81 in the first direction in the opening 80A, and a restricting portion (stopper) that restricts an upper limit position of the engaging portion 81 when the distance between the liquid ejection unit 22 and the maintenance part 38 is specified. According to this configuration, the engaging portion 81 abutting the restricting portion is displaced in the direction −D1 opposite to the first direction D1 against a biasing force of the biasing member, whereby the maintenance part 38 is positioned in the first direction D1. As described above, the positioning part 70 may include the restricting portion and the biasing member built in the support 80. In this case, the positioning part 70 can position the maintenance part 38 at the maintenance position MP by movement of the support 80 in the first direction D1 by the movement mechanism 50 and movement of the engaging portion 81, which is moved to the target position P1 by the movement of the support 80, relative to the support 80 against the biasing force of the biasing member in the direction −D1 opposite to the first direction D1.

The positioning part 70 may have a configuration not including the restricting portion 73 (stopper). For example, the control unit 100 may control a driving amount of the second drive unit 72 for each positioning part 70 to determine the positioning position P2 where the movable member moves the engaging portion 81 in the first direction D1.

The maintenance unit 30 may be dedicated to the flushing. For example, a liquid discharge operation may discharge a liquid to the cap 45C. In this case, the cleaning that is the liquid discharge operation may be pressurized cleaning or negative pressure cleaning. The pressurized cleaning is cleaning in which the liquid in the liquid ejection unit 22 is pressurized and is forcibly discharged from the nozzles 24. The negative pressure cleaning is cleaning in which a substantially closed space, which is formed by the cap 45C in the capping state and the nozzle surface 25 and communicates with the nozzles 24, is set to a negative pressure by driving of a suction pump coupled to the cap 45C through a tube, thereby forcibly suctioning and discharging the liquid from the nozzle 24.

The pulleys constituting the power transmission mechanism 52 include a movable pulley, and may be only fixed pulleys. A plurality of movable pulleys may be provided.

The power transmission mechanism 52 may use a rope, a chain, or the like instead of the configuration using the wire rope 59. In the case of a chain, a sprocket engageable with the chain may be used instead of the pulley.

The drive unit 51 is not limited to a cylinder, and may be a motor or a linear actuator.

The power transmission mechanism 52 that transmits the power of the drive unit 51 to the movable stand 37 and the support 80 is not limited to a wire type power transmission mechanism. A belt type power transmission mechanism, a rack-and-pinion power transmission mechanism, or the like may be used. Further, a cam type power transmission mechanism in the related art may be used.

The second direction +D2 that is a direction in which the maintenance part 38 is pulled out may be the −Y direction that is a direction opposite to the +Y direction, or may be the forward movement direction A1 or the backward movement direction A2.

The liquid supply method for supplying the liquid to the liquid ejection unit 22 is not limited to the pressurization method. For example, a water head difference method of supplying a liquid using a water head difference may be used.

In the above-described embodiment and the modification illustrated in FIG. 18, the cloth 32, which is an example of the consumable, may be replaced at the work position DP, or may be replaced together with the maintenance part 38. In particular, in the small-sized or medium-sized liquid ejection apparatus 11, since the maintenance part 38 is small-sized, the maintenance part 38 may be a disposable and replaceable type. In this case, since replacement work such as roll replacement is unnecessary, the replacement work is simple.

A maintenance member provided as a consumable in the maintenance part 38 is not limited to the cloth 32. For example, the maintenance member may be a liquid absorbing member made of paper or synthetic resin fiber.

The maintenance part 38 may not include consumables such as the cloth 32. In this case, at the work position DP, predetermined work such as maintenance, inspection, or component replacement for the maintenance part 38 may be performed.

The subject that performs the predetermined work at the work position DP is not limited to a worker such as a user or a serviceman, and may be a work robot.

The liquid ejection apparatus 11 may include a nozzle inspection unit configured to detect an ejection failure of the nozzle 24. A time when the nozzle inspection unit detects an ejection failure of the nozzle 24 may be one of cleaning timings for executing the liquid discharge operation. For example, the nozzle inspection unit drives the piezoelectric element 27 to such an extent that droplets are not ejected from the nozzle 24, and detects an ejection failure of the nozzle 24 based on residual vibration remaining in the liquid in the liquid chamber communicating with the nozzle 24. The nozzle inspection unit detects foreign matters, air bubbles, a thickened liquid (for example, thickened ink), and the like in the liquid in the nozzle 24 as the ejection failure of the nozzle 24.

An actuator that specifies a discharge method of the liquid ejection unit 22 may be a piezoelectric actuator (a laminated piezoelectric element or a thin-film piezoelectric element), a thermal actuator using an electrothermal conversion element such as a heating resistor, an electrostatic actuator including a diaphragm and a counter electrode, or the like.

The medium 99 is not limited to paper such as roll paper or single sheet paper, and may be an envelope, board paper, a label, or the like. In addition, the medium 99 is not limited to paper, and may be fabric, a synthetic resin film, a laminate medium, foil, clothes, or the like.

When the liquid ejection apparatus 11 is a printer, the liquid ejection apparatus 11 is not limited to a lateral printer or a serial printer, and may be a line printer.

The liquid ejection apparatus 11 is not limited to an inkjet printer that ejects a liquid such as ink. The liquid ejection apparatus 11 may be an apparatus that ejects a liquid other than ink. The state of the liquid to be ejected from the liquid ejection unit 22 of the liquid ejection apparatus 11 includes a particle state, a teardrop state, and a state of tailing like a thread. The liquid mentioned here may sufficiently be any material that can be ejected from the liquid ejection apparatus 11. For example, the liquid may sufficiently be any substance in a liquid phase and includes a liquid material high or low in viscosity, sol, gel water, other inorganic solvents, organic solvents, solutions, and a fluid material such as a liquid resin and liquid metal (metal melt). The liquid includes not only a liquid as one state of a substance, but also a liquid obtained by dissolving, dispersing, or mixing particles of a functional material formed of a solid substance such as pigments or metal particles in a solvent. Here, the term “ink” includes various types of liquid compositions such as general water-based ink, oil-based ink, gel ink, and hot melt ink. Specific examples of the liquid ejection apparatus 11 include a liquid ejection apparatus that ejects a liquid containing, in a dispersed or dissolved form, a material such as an electrode material or a coloring material used for manufacturing, for example, a liquid crystal display, an electroluminescence display (EL), a surface-emitting display, and a color filter. The liquid ejection apparatus may be a liquid ejection apparatus that ejects a bioorganic substance used for manufacturing a biochip, a liquid ejection apparatus that is used as a precision pipette and ejects a liquid to be a sample, a textile printing apparatus, a micro dispenser, or the like. The liquid ejection apparatus may be a liquid ejection apparatus that ejects lubricating oil to a precision machine such as a timepiece or a camera in a pinpoint manner, or a liquid ejection apparatus that ejects a liquid of a transparent resin such as ultraviolet curable resin onto a substrate in order to form a minute hemispherical lens (optical lens) used for an optical communication element or the like, or the like. The liquid ejection apparatus may be a liquid ejection apparatus that ejects an etching liquid such as acid or alkali in order to etch a substrate or the like.

### Definitions

The expression “at least one” used in the present specification means “one or more” of desired options. For example, the expression “at least one” used in the present specification means “only one option” or “both of two options” when the number of options is two. As another example, the expression “at least one” used in the present specification means “only one option” or “a combination of any two or more options” when the number of options is three or more.

### Technical Ideas

As below, the technical ideas grasped from the above-described embodiment and the modifications will be described together with effects.
[1] A maintenance unit is a maintenance unit to be used in a liquid ejection apparatus including a liquid ejection unit, the maintenance unit including: a maintenance part configured to perform maintenance on the liquid ejection unit; a movement mechanism configured to move the maintenance part in a first direction toward the liquid ejection unit; and a positioning part, in which the maintenance part includes an engaging portion engageable with the positioning part, the movement mechanism includes a drive unit and a support configured to move in the first direction by power of the drive unit and support the maintenance part, and the positioning part engages with the engaging portion of the maintenance part that is moved in the first direction together with the support, and moves the maintenance part relative to the support in a direction parallel to the first direction to position the maintenance part with respect to the liquid ejection unit. According to this configuration, since the movement mechanism moves the maintenance part in the first direction by the support, a movement amount of the maintenance part is secured. The positioning part engages with the engaging portion of the maintenance part that is moved in the first direction, and moves the maintenance part relative to the support in a direction parallel to the first direction, thereby positioning the maintenance part with respect to the liquid ejection unit. Therefore, the movement amount of the maintenance part can be secured, and the maintenance part can be positioned with respect to the liquid ejection unit with high accuracy. For example, a distance between the maintenance part and the liquid ejection unit in the first direction can be specified with high accuracy.
[2] In the maintenance unit according to [1], the positioning part may be fixed to a body frame that supports the liquid ejection unit. According to this configuration, the maintenance part can be positioned with respect to the liquid ejection unit with higher accuracy. For example, the distance between the maintenance part and the liquid ejection unit can be specified with higher accuracy.
[3] In the maintenance unit according to [1] or [2], the engaging portion may engage with the support moving in the first direction. According to this configuration, since the support moving in the first direction moves the maintenance part in the first direction via the engaging portion, the posture of the maintenance part during the movement is easily stabilized.
[4] In the maintenance unit according to any one of [1] to [3], the positioning part may position the maintenance part with respect to the liquid ejection unit by moving the engaging portion relative to the support in the first direction. According to this configuration, when the positioning part moves the engaging portion in the first direction, it is not necessary to move the support of the movement mechanism in the first direction.
[5] In the maintenance unit according to any one of [1] to [4], the engaging portion may be a shaft member, the support may have an opening through which the engaging portion passes, and in the first direction, a length of the opening may be larger than a thickness of the shaft member. According to this configuration, when the positioning part moves the engaging portion in the first direction, it is not necessary to move the support of the movement mechanism in the first direction.
[6] In the maintenance unit according to any one of [1] to [5], the positioning part may include a movable member movable between a released state in which the movable member is not engaged with the engaging portion and a positioning state in which the movable member is engaged with the engaging portion to position the engaging portion in the first direction, and the movable member may engage with the engaging portion. According to this configuration, the arrangement of the movable member at a position where the movable member does not interfere with a movement path of the engaging portion and the movement of the movable member engaged with the engaging portion can be implemented
[7] In the maintenance unit according to any one of [1] to [6], the movable member may be a lever that changes a posture between the released state and the positioning state. According to this configuration, when the lever is in the released state, the lever does not interfere with the movement path of the engaging portion moved in the first direction by the support. When the lever is in the positioning state, it is possible to specify the distance between the liquid ejection unit and the maintenance part by engaging with the engaging portion. Since the movable member is a lever, the released state and the positioning state can be easily implemented with a relatively simple configuration and a small space.
[8] In the maintenance unit according to any one of [1] to [7], three or more positioning parts may be provided, and the three or more positioning parts may be arranged at arrangement positions such that projection positions on a virtual plane orthogonal to the first direction are three or more different positions. According to this configuration, since the maintenance part is supported at three or more different positions on a virtual plane, the facing portion of the maintenance part can be positioned to be parallel to the virtual plane. Therefore, parallelism between a nozzle surface of the liquid ejection unit and the facing portion of the maintenance part is easily secured.
[9] In the maintenance unit according to any one of [1] to [8], the movable member may be provided with a guide member having an inclined surface configured to guide the engaging portion in a direction orthogonal to the first direction. According to this configuration, the engaging portion lifted by the pivot lever can be positioned not only in the first direction but also in a direction orthogonal to the first direction. Therefore, parallelism between a nozzle surface of the liquid ejection unit and the facing portion of the maintenance part is easily secured.
[10] In the maintenance unit according to any one of [1] to [9], the positioning part may include a restricting portion configured to restrict movement of the engaging portion in the first direction and an adjustment portion configured to adjust a position of the regulation portion in the first direction. According to this configuration, an upper limit position of the engaging portion can be restricted by the restricting portion, and the upper limit position can be adjusted.
[11] In the maintenance unit according to any one of [1] to [10], the maintenance unit further includes: a control unit; and a detection unit configured to detect that the engaging portion is moved in the first direction to a target position together with the support, in which assuming the drive unit to be a first drive unit, the positioning part includes the movable member engageable with the engaging portion that is moved to the target position and a second drive unit configured to move the movable member from the released state to the positioning state, and the control unit (A) causes the first drive unit to perform driving in a driving direction of moving the maintenance part in the first direction, (B) stops the driving of the first drive unit when the detection unit detects that the engaging portion is moved to the target position, and (C) causes the second drive unit to perform driving to move the engaging portion from the target position to a positioning position by the movable member. According to this configuration, the movement of the support by the driving of the first drive unit and the movement of the engaging portion by the driving of the second drive unit are linked, and thus it is possible to quickly position the maintenance part at a specified position with respect to the liquid ejection unit.
[12] In the maintenance unit according to any one of [2] to [11], the movement mechanism may include a slide rail that allows the maintenance part to move in a second direction orthogonal to the first direction, and the slide rail may allow the maintenance part to move to a position where at least a facing portion, which is a portion of the maintenance part facing the liquid ejection unit during maintenance, does not overlap the body frame in a viewing direction of the maintenance part as viewed from a direction opposite to the first direction. According to this configuration, the maintenance part can be easily replaced.
[13] In the maintenance unit according to any one of [1] to [12], the maintenance part may include a delivery roller around which cloth is wound in a roll shape, a winding roller configured to wind up the cloth from the delivery roller, and a third drive unit configured to drive the winding roller. According to this configuration, the maintenance of the liquid ejection unit can be performed with the cloth, and good maintenance can be continued by changing the portion of the cloth stained in the maintenance to an unused portion of the cloth.
[14] In the maintenance unit according to [13], the maintenance part may include a roller mechanism including the delivery roller and the winding roller, and a facing portion of the cloth facing the liquid ejection unit, and the engaging portion may be provided between the roller mechanism and the facing portion in the first direction. According to this configuration, since the engaging portion is positioned at a position close to the facing portion, the liquid ejection unit and the facing portion are easily kept parallel to each other.
[15] A liquid ejection apparatus includes: the maintenance unit according to any one of [1] to [14]; and the liquid ejection unit. According to this configuration, in the liquid ejection apparatus, the movement amount of the maintenance part in the maintenance unit can be secured, and the distance between the maintenance part and the liquid ejection unit can be specified with high accuracy.
[16] A liquid ejection apparatus includes: the maintenance unit according to [13] or [14]; and the liquid ejection unit, in which in a state where the maintenance part is positioned with respect to the liquid ejection unit, the maintenance part performs the maintenance in which a liquid ejected by the liquid ejection unit is received by the cloth. According to this configuration, in the liquid ejection apparatus, the movement amount of the maintenance part in the maintenance unit can be secured, and the distance between the maintenance part and the liquid ejection unit can be specified with high accuracy. It is possible to appropriately perform the maintenance in which the liquid ejected by the liquid ejection unit is received by the cloth.
[17] A maintenance unit is a maintenance unit to be used in a liquid ejection apparatus including a liquid ejection unit having a nozzle surface, the maintenance unit including: a maintenance part including a delivery roller around which cloth is wound in a roll shape, a winding roller configured to wind up the cloth from the delivery roller, a drive unit configured to drive the winding roller, and a facing portion configured to cause a maintenance surface of the cloth to face the nozzle surface of the liquid ejection unit; a movement mechanism configured to move the maintenance surface in a first direction toward the nozzle surface of the liquid ejection unit; and an engaging portion provided to be movable integrally with the facing portion and configured to engage with the movement mechanism, in which in the first direction, the engaging portion is provided between the facing portion and one of the delivery roller and the winding roller that is closer to the facing portion. According to this configuration, since the engaging portion is provided at a position close to the facing portion, the nozzle surface and the maintenance surface are easily kept parallel to each other.

What is claimed is:

1. A maintenance unit to be used in a liquid ejection apparatus including a liquid ejection unit, the maintenance unit comprising:
a maintenance part configured to perform maintenance on the liquid ejection unit;
a movement mechanism configured to move the maintenance part in a first direction toward the liquid ejection unit; and
a positioning part, wherein
the maintenance part includes an engaging portion engageable with the positioning part,
the movement mechanism includes a drive unit and a support configured to move in the first direction by power of the drive unit and support the maintenance part, and
the positioning part engages with the engaging portion of the maintenance part that is moved in the first direction together with the support, and moves the maintenance part relative to the support in a direction parallel to the first direction to position the maintenance part with respect to the liquid ejection unit.

2. The maintenance unit according to claim 1, wherein
the positioning part is fixed to a body frame that supports the liquid ejection unit.

3. The maintenance unit according to claim 1, wherein
the engaging portion engages with the support moving in the first direction.

4. The maintenance unit according to claim 1, wherein
the positioning part positions the maintenance part with respect to the liquid ejection unit by moving the engaging portion relative to the support in the first direction.

5. The maintenance unit according to claim 1, wherein
the engaging portion is a shaft member,
the support has an opening through which the engaging portion passes, and
in the first direction, a length of the opening is larger than a thickness of the shaft member.

6. The maintenance unit according to claim 1, wherein
the positioning part includes a movable member movable between a released state in which the movable member is not engaged with the engaging portion and a positioning state in which the movable member is engaged with the engaging portion to position the engaging portion in the first direction, and
the movable member engages with the engaging portion.

7. The maintenance unit according to claim 6, wherein
the movable member is a lever that changes a posture between the released state and the positioning state.

8. The maintenance unit according to claim 1, wherein
three or more positioning parts are provided, and
the three or more positioning parts are arranged at arrangement positions such that projection positions on a virtual plane orthogonal to the first direction are three or more different positions.

9. The maintenance unit according to claim 6, wherein
the movable member is provided with a guide member having an inclined surface configured to guide the engaging portion in a direction orthogonal to the first direction.

10. The maintenance unit according to claim 6, wherein
the positioning part includes a restricting portion configured to restrict movement of the engaging portion in the first direction, and an adjustment portion configured to adjust a position of the restricting portion in the first direction.

11. The maintenance unit according to claim 6, further comprising:
a control unit; and
a detection unit configured to detect that the engaging portion is moved in the first direction to a target position together with the support, wherein
assuming the drive unit to be a first drive unit, the positioning part includes the movable member engageable with the engaging portion that is moved to the target position and a second drive unit configured to move the movable member from the released state to the positioning state, and
the control unit
causes the first drive unit to perform driving in a driving direction of moving the maintenance part in the first direction,
stops the driving of the first drive unit when the detection unit detects that the engaging portion is moved to the target position, and
causes the second drive unit to perform driving to move the engaging portion from the target position to a positioning position by the movable member.

12. The maintenance unit according to claim 2, wherein
the movement mechanism includes a slide rail that allows the maintenance part to move in a second direction orthogonal to the first direction, and
the slide rail allows the maintenance part to move to a position where at least a facing portion, which is a portion of the maintenance part facing the liquid ejection unit during maintenance, does not overlap the body frame in a viewing direction of the maintenance part as viewed from a direction opposite to the first direction.

13. The maintenance unit according to claim 1, wherein
the maintenance part includes a delivery roller around which cloth is wound in a roll shape, a winding roller configured to wind up the cloth from the delivery roller, and a third drive unit configured to drive the winding roller.

14. The maintenance unit according to claim 13, wherein
the maintenance part includes a facing portion that is a portion of the cloth facing the liquid ejection unit, and
in the first direction, the engaging portion is provided between the facing portion and one of the delivery roller and the winding roller that is closer to the facing portion.

15. A liquid ejection apparatus comprising:
the maintenance unit according to claim 1; and
the liquid ejection unit.

16. A liquid ejection apparatus comprising:
the maintenance unit according to claim 13; and
the liquid ejection unit, wherein
in a state where the maintenance part is positioned with respect to the liquid ejection unit, the maintenance part performs the maintenance in which a liquid ejected by the liquid ejection unit is received by the cloth.
